(19) United States
(12) Patent Application Publication
(10) Pub. No.: US 2026/0288844 A1
(43) Pub. Date: Sep. 24, 2026

(54) SYSTEM

(71) Applicant: SoftBank Group Corp., Tokyo (JP)

(72) Inventor: Kazuo KAWATA, Tokyo (JP)

(73) Assignee: SoftBank Group Corp., Tokyo (JP)

(21) Appl. No.: 19/565,619

(22) Filed: Mar. 13, 2026

(30) Foreign Application Priority Data
Mar. 19, 2025 (JP) 2025-045098

(51) Int. Cl. G06F 16/34; G06F 16/21; G06F 16/3329; G06F 40/103

(52) U.S. Cl. CPC G06F 16/345; G06F 16/219; G06F 16/33295; G06F 40/103

(57) ABSTRACT

A system includes a processor that is configured to automatically collect information on competitors from at least one of the Internet and a database, convert the collected information into a text format and perform preprocessing to remove noise from the converted information, and generate a prompt for instructing a generative artificial intelligence model to analyze the information and generate a summary, and analyze the information and generate the summary based on the prompt by using the generative artificial intelligence model.

### CROSS-REFERENCE TO RELATED APPLICATION

This application is based on and claims priority under 35 USC 119 from Japanese Patent Application No. 2025-045098 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, enterprises have increasingly needed to monitor and analyze competitor activities, including competitor strategies and new product releases, on a continuous and timely basis. However, conventional competitor analysis workflows rely heavily on manual operations, such as individually searching the Internet and databases, collecting documents, reading through heterogeneous formats, and manually extracting and summarizing key points. This manual approach is time-consuming, labor-intensive, and prone to omissions and human bias, particularly when the volume of information is large or when multiple competitors must be tracked in parallel.

Furthermore, although generative artificial intelligence models have become capable of sophisticated text analysis and summarization, there is no integrated mechanism in conventional systems that automatically collects competitor information, preprocesses the information, and generates appropriate prompts that instruct a generative artificial intelligence model to perform targeted analysis and summarization. As a result, effective utilization of generative artificial intelligence for competitor analysis depends on the skill of individual users in designing prompts, which leads to inconsistent analysis quality and unstable output.

In addition, conventional systems do not sufficiently support automatic extraction of specific types of competitive information, such as competitor strategies or new product information, from collected data, nor do they ensure that such extracted information is reliably included in the generated summaries. This lack of automation and structure makes it difficult for enterprises to obtain comprehensive, consistent, and up-to-date competitive intelligence in a form that can be readily used for decision-making and internal reporting.

Accordingly, there is a need for a system that can automatically collect competitor information from the Internet or databases, normalize and clean such information, generate prompts suitable for generative artificial intelligence models by using natural language processing techniques, and cause the generative artificial intelligence models to analyze and summarize the information, including specific elements such as competitor strategies and new product information, in an efficient and consistent manner.

### SUMMARY

In order to solve at least part of the above problems, an embodiment of the invention provides a system comprising a processor, wherein the processor is configured to automatically collect information on competitors from at least one of the Internet and a database. The processor converts the collected information into a text format, performs preprocessing to remove noise from the converted information, and thereby generates normalized text data suitable for analysis.

The processor is further configured to generate a prompt for instructing a generative artificial intelligence model to analyze the normalized text data and to generate a summary. In one embodiment, the processor uses a natural language processing technique to generate the prompt so that the prompt includes explicit instructions for analysis and summarization, such as the type of information to be extracted, the desired level of detail, and the output structure. The processor then provides the prompt and the normalized text data to the generative artificial intelligence model and causes the generative artificial intelligence model to analyze the information and generate the summary based on the prompt.

In another embodiment, the processor is configured to cause the generative artificial intelligence model, in response to the generated prompt, to extract at least one of competitor strategies and new product information from the normalized text data, and to generate the summary including the at least one of the competitor strategies and the new product information. By explicitly instructing the generative artificial intelligence model via the prompt, the processor ensures that information critical for competitive analysis is systematically captured in the summarization result.

Through these configurations, the system automates the end-to-end workflow from competitor information collection, text conversion, and noise removal, to prompt generation, analysis, and summarization using a generative artificial intelligence model. As a result, the system enables efficient, consistent, and timely generation of summaries that include key competitive intelligence elements, thereby reducing manual workload and dependence on user-specific skills in prompt design, and improving the reliability and utility of competitor analysis within an organization.

The term “processor” refers to any hardware and/or software component, including but not limited to one or more central processing units (CPUs), graphics processing units (GPUs), microcontrollers, digital signal processors, or combinations thereof, that executes instructions to perform the functions described in the claims.

The term “system” refers to an arrangement comprising at least the processor and, optionally, one or more memories, communication interfaces, storage devices, and peripheral components, which cooperate to execute the processing described in the claims.

The term “Internet” refers to a global network of interconnected computer networks that use standard communication protocols, such as the Internet Protocol (IP), to enable data communication and information retrieval from remote servers and services.

The term “database” refers to any structured or semi-structured data store, including relational databases, NoSQL databases, data warehouses, and data lakes, that can be accessed programmatically to retrieve and store information.

The term “competitors” refers to entities, such as companies, organizations, or business units, that provide products or services that are identical, similar, or substitutable with respect to those of a subject company or organization.

The term “information on competitors” refers to any data or content related to competitors, including but not limited to press releases, product announcements, technical documentation, marketing materials, financial reports, web pages, presentations, and news articles.

The term “text format” refers to a representation of information as character-based data, such as plain text, markup text, or other machine-readable text encodings, which can be input to natural language processing or generative artificial intelligence models.

The term “noise” refers to portions of the collected information that are irrelevant, redundant, inconsistent, or otherwise undesirable for analysis, such as HTML tags, advertisements, navigation menus, formatting artifacts, boilerplate text, or non-informative content.

The term “preprocessing” refers to any operation performed on the collected information prior to analysis, including but not limited to format conversion, character encoding normalization, removal of noise, tokenization, language detection, and segmentation into analytically meaningful units.

The term “generative artificial intelligence model” refers to a machine learning model, such as a large language model, that is trained to generate text or other content in response to input prompts, and that can perform tasks including analysis, summarization, and information extraction.

The term “prompt” refers to a piece of input text, including instructions, questions, examples, or contextual information, that is provided to the generative artificial intelligence model to specify how the model should analyze data and generate output.

The term “analyze the information” refers to processing the collected and preprocessed information by means of the generative artificial intelligence model to identify structures, relationships, key points, patterns, or specific items of interest, such as strategies or product features.

The term “summary” refers to a condensed representation of the collected and preprocessed information that preserves salient points, such as main topics, key facts, and extracted competitive intelligence, while omitting less relevant details.

The term “natural language processing technique” refers to any computational method or algorithm that operates on human language text, including but not limited to tokenization, part-of-speech tagging, syntactic parsing, semantic analysis, intent detection, and text generation, and that is used herein to construct or refine prompts.

The term “competitor strategies” refers to plans, policies, or approaches employed by competitors in areas such as product development, pricing, market positioning, customer targeting, technology adoption, and geographic expansion, as described or implied in the collected information.

The term “new product information” refers to data relating to products or services newly developed, announced, or released by competitors, including product names, features, technical specifications, target markets, pricing schemes, and release schedules.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

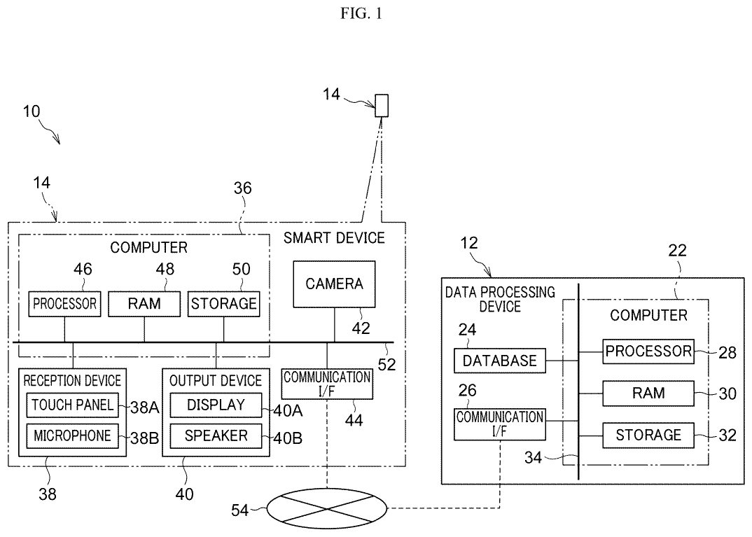

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

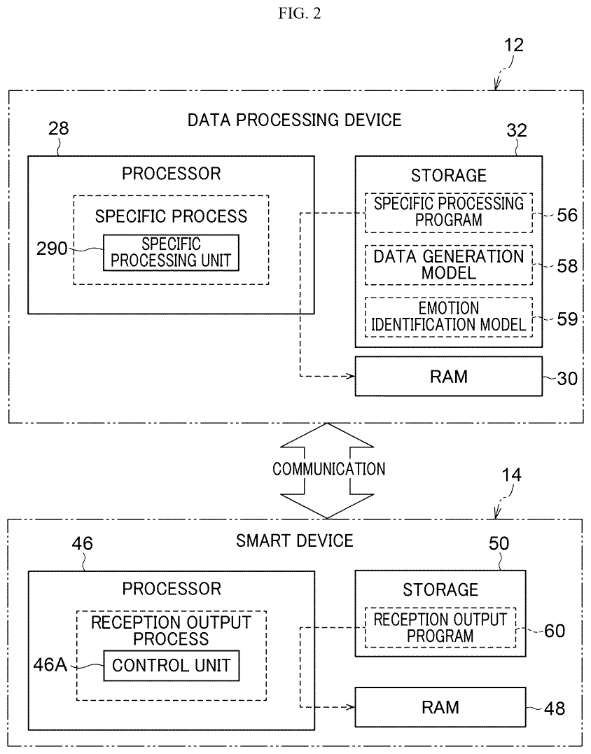

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional competitive-intelligence workflows for processing externally obtained documents suffer from several technical limitations in the way computing resources are utilized. In many existing systems, heterogeneous source files such as electronic documents, page-description files, and plain text are manually or semi-manually converted and cleaned before being passed to a remote inference engine. This often results in inconsistent text normalization, inclusion of noise such as unnecessary line breaks and special symbols, and ad-hoc prompt sentences for a generative AI model. As a consequence, the input sequences fed to the model are suboptimal from the standpoint of token efficiency, semantic clarity, and controllability of the model output, which leads to degraded summary quality, unnecessary consumption of network bandwidth and compute cycles, and increased latency. Furthermore, conventional systems typically do not integrate, under a unified processor-centric architecture, (i) structured acquisition of external documents, (ii) deterministic text preprocessing tailored to downstream generative AI consumption, (iii) systematic construction of prompt sentences specifying analytical viewpoints and output formats, and (iv) lifecycle management of both source documents and generated summaries. Instead, these operations are often scattered across different tools or services that are loosely coupled, which complicates automation, hinders reproducibility of results, and makes it difficult to trace which prompt configuration and which model instance produced a given summary. Additionally, existing solutions usually treat the generative AI model as a black-box service, without a mechanism at the processor level to programmatically constrain the semantic focus of the generated summaries. For example, information regarding business policy, target users, technical features, and implementation timing of a competitive entity may not be reliably extracted unless the human operator manually crafts a highly specific prompt. This dependence on manual prompt engineering not only reduces throughput but also leads to variability in summary content, undermining the utility of the system for downstream decision-support processes.

Accordingly, there is a need for an improved computer-implemented system and server-side processing architecture that: (1) automatically acquires competitor-related document data from communication networks or information storage devices; (2) converts and normalizes the document data into a character information format optimized for generative AI processing; (3) programmatically generates and applies structured prompt sentences that precisely define summarization viewpoints and output formats; and (4) stores and manages both the original document data and the generated summaries, together with associated identification and state information, in a manner that enhances efficiency, consistency, and traceability of competitive-intelligence summarization on computing platforms.

The specific processing by the specific processing unit 290 of the data processing device 12 in Example 1 is realized by the following means.

The present invention provides a server comprising a processor configured to acquire document data relating to a competitive entity from a communication network or an information storage device, convert the document data from a document format into a character information format and format the character information format by deleting unnecessary line breaks and special symbols using a script described in a programming language, transmit the formatted character information format to an external processing apparatus via an encrypted communication scheme, transmit inquiry information including a prompt sentence for instructing generation of a summary of the formatted character information format to a generative AI model operating on the external processing apparatus and obtain response information including the summary from the generative AI model, generate the prompt sentence using natural language processing and include, in the prompt sentence, at least one viewpoint of a target of summarization and an output format so as to control contents of analysis performed by the generative AI model, set the prompt sentence such that the summary obtained from the generative AI model includes information relating to at least a business policy, a provision target, a technical feature, and an implementation timing of the competitive entity, store the document data and the summary in a storage device in association with each other, manage identification information of the document data, processing state information, and identification information of the generative AI model, and provide the summary to a user terminal via electronic communication. This enables an integrated, processor-controlled improvement of computer functionality in which heterogeneous external documents are automatically normalized for generative AI consumption, prompt sentences are systematically constructed to constrain and focus model behavior, summaries containing predetermined categories of competitive information are generated in a consistent and reproducible manner, and both inputs and outputs are managed with associated metadata, thereby enhancing processing efficiency, stability of summarization quality, and traceability within a computer-implemented competitive-intelligence system.

The term “processor” refers to one or more hardware processing units, such as a central processing unit, a graphics processing unit, or other arithmetic logic circuitry, and may include associated control logic configured to execute program instructions.

The term “module” refers to a functional unit implemented by hardware, software, or any combination of hardware and software, configured to perform a specified processing operation under control of the processor.

The term “information acquisition module” refers to a module configured to obtain document data from a communication network or from an information storage device in response to control by the processor.

The term “document data” refers to electronically stored information representing content such as text, images, or layouts, in one or more document formats including, but not limited to, page-description formats, word-processing formats, and plain text formats.

The term “competitive entity” refers to an organization, business, group, or other actor whose activities, products, or services are the subject of analysis for competitive-intelligence purposes.

The term “communication network” refers to any wired or wireless data communication infrastructure, including local area networks, wide area networks, and global networks, that enables electronic data transfer between computing devices.

The term “information storage device” refers to a physical or virtual storage resource, such as a magnetic disk, solid-state memory, optical medium, or network-attached storage, configured to store and provide access to digital data.

The term “preprocessing module” refers to a module configured to convert document data from a document format into a character information format and to normalize or clean the character information format according to predefined rules.

The term “character information format” refers to a representation of document data as a sequence of characters, such as a plain text string, suitable for processing by natural language processing algorithms and generative AI models.

The term “script described in a programming language” refers to an executable sequence of instructions written in a high-level or low-level programming language and interpreted or compiled for execution by a computing environment under control of the processor.

The term “unnecessary line breaks” refers to line termination characters or sequences that are not semantically meaningful and that can be removed or replaced without altering the substantive content of the text.

The term “special symbols” refers to characters, control codes, or non-printable marks that are not required for semantic understanding of the text and that may be removed or normalized to improve downstream text processing.

The term “communication module” refers to a module configured to send and receive data via one or more communication networks using specified communication protocols.

The term “encrypted communication scheme” refers to a communication protocol or method that applies cryptographic techniques to protect data transmitted between computing devices against unauthorized access or tampering.

The term “external processing apparatus” refers to a computing system or service that is physically or logically separate from the server and that performs processing of data received from the server.

The term “analysis module” refers to a module configured to generate inquiry information including a prompt sentence, transmit the inquiry information to a generative AI model, and obtain response information from the generative AI model.

The term “inquiry information” refers to data transmitted to a generative AI model that includes at least a prompt sentence and may further include character information format data and control parameters for the model.

The term “prompt sentence” refers to a natural language or structured instruction provided as part of inquiry information to specify a processing task, such as summarization, and to guide the behavior of a generative AI model.

The term “generative AI model” refers to a trained machine learning model configured to generate output data, such as natural language text, in response to input data and instructions, using generative algorithms including, but not limited to, neural network-based models.

The term “response information” refers to data returned from a generative AI model in response to inquiry information, including at least generated text corresponding to the requested task.

The term “summary” refers to text generated from input document data that condenses the input while preserving essential information according to one or more specified viewpoints.

The term “natural language processing” refers to computational techniques for analyzing, understanding, generating, or transforming human language data represented as text.

The term “viewpoint of a target of summarization” refers to a specified perspective, focus, or aspect, such as business policy or technical features, that the summary is requested to emphasize.

The term “output format” refers to a specified structural or stylistic form of generated text, such as bullet points, paragraphs, a fixed word length, or inclusion of labeled sections.

The term “business policy” refers to information relating to an overall direction, strategy, or operational guideline adopted by an organization or competitive entity.

The term “provision target” refers to a category of users, customers, markets, or application domains to which a product, service, or solution is directed.

The term “technical feature” refers to a characteristic, property, or mechanism of a technology, product, or system that defines its technical structure, function, or performance.

The term “implementation timing” refers to temporal information, such as a schedule, milestone, release date, or deployment period, relating to the execution or introduction of an activity, product, or service.

The term “management module” refers to a module configured to store and manage document data, summaries, and associated metadata in one or more storage devices under the control of the processor.

The term “storage device” refers to any hardware component or logical unit capable of storing digital information, including volatile and non-volatile memory and network-based storage resources.

The term “identification information” refers to data that uniquely or distinctively identifies an item such as document data, a summary, or a model instance, including identifiers, keys, or labels.

The term “processing state information” refers to data indicating a stage, status, or result of processing applied to document data or summaries, such as pending, in-progress, or completed.

The term “identification information of the generative AI model” refers to data that distinguishes a particular generative AI model instance or configuration, including model name, version, or parameter set.

The term “output module” refers to a module configured to provide generated summaries or other processed results from the server to a user terminal or other destination system.

The term “user terminal” refers to a computing device operated by a user, such as a workstation, portable terminal, or other electronic apparatus, that is configured to communicate with the server and present information to the user.

The term “electronic communication” refers to transmission and reception of digital data between devices using electrical, optical, or radio signals over one or more communication networks.

In one embodiment, a server, a terminal, and a user cooperate to implement the system. The server includes at least one processor, a memory, a network interface, and one or more storage devices. The terminal includes a processor, a memory, a user interface, and a network interface. The user operates the terminal to initiate processing and to review results. The server executes software modules including an information acquisition module, a preprocessing module, a communication module, an analysis module, a management module, and an output module. These modules may be implemented as separate processes or components in an application framework, for example in a server-side program written in a high-level language and executed on an operating system such as a server-oriented operating system.

The terminal executes application software such as a web browser, a document viewer, and scripting tools. The terminal runs, for example, a web browser equivalent to commonly used browsers to download competitor documents, and runs a document processing application equivalent to a commercial page-description document tool (for example, a tool having functions similar to Adobe Acrobat) to convert page-description documents into plain text. The terminal also runs an interpreter for a programming language such as Python to execute preprocessing scripts. The user uses the terminal to select input files, confirm preprocessing results, and send data to the server via secure communication.

The server uses a communication module to receive character-based text data from the terminal via an encrypted transport protocol such as HTTPS over TCP/IP. The server stores received text data and associated metadata in a storage device such as a relational database management system (for example, a system similar to PostgreSQL or MySQL) or a key-value store. The server maintains for each document an identifier, an origin (such as source URL or file path), timestamps, and a processing state. The server further stores references to the generative AI model version used for each summary and any configuration parameters applied.

The terminal uses a preprocessing module to transform heterogeneous document formats into a normalized character information format. The terminal reads page-description files using the document processing application and exports them as plain text files. The terminal reads word-processing documents using a word-processing application and saves them as plain text. The terminal then executes a script in a programming language such as Python that loads the text files, removes unnecessary line breaks and special symbols, normalizes whitespace, and optionally merges multiple files into a single text stream. The terminal, for example, removes consecutive newline characters, eliminates non-printable characters, and replaces unusual spacing with standard spaces. This preprocessing reduces token fragmentation and noise in the input sequences supplied later to the generative AI model, thereby reducing computational overhead and improving the model's ability to identify coherent semantic units.

The server uses the analysis module to construct a prompt sentence and to interact with a generative AI model executed on an external processing apparatus. In one embodiment, the external processing apparatus is a remote computing system providing an inference endpoint for a large-scale neural network model. The generative AI model is a transformer-based neural network, such as a multi-layer self-attention architecture with, for example, dozens of encoder-decoder blocks, multi-head attention mechanisms, and position-wise feed-forward networks. The model uses tokenization to convert input characters into token sequences, uses learned embedding vectors to represent tokens in a high-dimensional space, and applies stacked attention layers to model long-range dependencies. The server passes text and instructions to the generative AI model via an application programming interface, specifying model identifiers, maximum token lengths, temperature parameters, and other decoding settings.

The server uses natural language processing techniques to generate structured prompt sentences. The server analyzes the preprocessed text to infer document type and domain-specific cues, for example by applying keyword detection, part-of-speech tagging, and simple statistical measures. The server then assembles a prompt template from stored components. For example, the server constructs prompt sentences such as: “Summarize the following competitor document focusing on business strategy, main products, target customers, and planned release schedule. Provide the summary in bullet points.” or

“You are a professional market analyst. Read the following text and create a concise summary that highlights the competitor's product features, technical differentiators, target segments, and timeline for implementation.”or

“Summarize the following presentation in about 300 words. Focus on new products, key technologies, differentiation points, and market positioning.”

The server inserts such prompt sentences ahead of the preprocessed document text, forming inquiry information that the server transmits to the external generative AI model. The server thereby uses the prompt sentence not merely as a label but as a structured control sequence that constrains the model's attention toward specific categories of information, such as business policy, provision target, technical feature, and implementation timing. This structured prompt configuration reduces variability in output and improves alignment between the summary content and the desired analytical viewpoints.

The server configures the generative AI model to operate using predetermined hyperparameters and decoding algorithms. The server sets, for example, a beam search or nucleus sampling strategy with fixed beam width or top-p value, a maximum token length for the output, and a temperature parameter controlling randomness. The server uses these settings in conjunction with the prompt sentence to bias the model toward concise, information-dense summaries rather than verbose or generic responses. The server thereby improves computational efficiency by avoiding excessively long outputs and by reducing the number of iterative calls needed to obtain acceptable summaries.

From the perspective of training and internal operation, the generative AI model is pre-trained on large corpora using masked language modeling or next-token prediction objectives and then fine-tuned using supervised learning and/or reinforcement learning from human feedback. During training, the model minimizes a loss function such as cross-entropy between predicted token distributions and ground-truth tokens. The model updates weights in its attention layers and feed-forward layers using gradient-based optimization, for example stochastic gradient descent variants with adaptive learning rates. By the time the model is deployed for inference, it has learned complex language patterns and can produce contextually appropriate summarizations for diverse input texts. The server leverages this pre-trained structure but further directs it via prompt sentences so that the model's general capabilities are harnessed for a specific competitive-intelligence summarization task. The server uses the management module to maintain a data structure that associates document identifiers, raw text, cleaned text, prompt sentences, generative AI model identifiers, configuration parameters, and generated summaries. The server records each inference event with associated metadata such as timestamps, processing duration, and status codes. The server thus enables traceability: a particular summary can be traced back to a specific input document, a specific prompt sentence, and a specific model configuration. This structure improves system reliability by enabling systematic auditing and reproducibility. The server also uses indexes on the document identifiers and selected fields to support efficient retrieval operations, thereby reducing latency when users request previously generated summaries.

The server uses the output module to transmit generated summaries to the terminal via electronic communication. The server may send summaries via an email protocol such as Simple Mail Transfer Protocol, or render them in a web-based user interface using a server-side web framework. The server may also expose a programmatic endpoint that returns summaries as structured data to an enterprise system. In each case, the server realizes a technical data flow from acquisition to preprocessing to inference to storage to output, without requiring manual intervention in intermediate steps. The user receives the summary on the terminal, for example via an email client or a web browser, and does not need to inspect the large original document to obtain key information.

The terminal uses its user interface to display the summaries and associated metadata, such as document titles, competitors'names, upload times, and processing states. The terminal may also display indicators generated by the server, such as confidence metrics derived from model probabilities or heuristic measures. This presentation assists the user in prioritizing which summaries to review and which documents to investigate further. The terminal may further allow the user to input additional constraints or feedback, which the server can use to select different prompt templates or modify weights in the prompt-generation logic for future requests.

The server improves computer technology in several ways. First, by normalizing input text through systematic removal of unnecessary line breaks and special symbols before tokenization, the server reduces the number of tokens generated for a given document, which directly reduces computational load in the generative AI model's attention layers. Because self-attention has complexity that scales superlinearly with sequence length, this reduction produces a tangible improvement in processing speed and resource utilization. Second, by generating structured prompt sentences that specify particular fields of interest, the server decreases the entropy of the model's output distribution and thus shortens or simplifies the decoding process, reducing the number of unstable or off-topic completions that would otherwise require re-requests or manual correction. Third, by storing and indexing documents, prompt sentences, and summaries together with model identifiers and states, the server optimizes data management, enabling incremental re-processing when model versions change and reducing redundant re-inference.

The server also enables a non-conventional processing pipeline that differs from mere human task automation. Instead of simply replicating manual reading and summarization, the server decomposes the task into machine-optimized sub-tasks: document normalization, prompt construction, model-driven feature extraction, and structured output storage. The generative AI model is configured to employ high-dimensional embeddings and attention weights that discover patterns and relationships across long documents that human readers may miss or may require more time to detect. The server, by enforcing prompt-level constraints and preprocessing specifications, controls the internal activation patterns of the model to preferentially attend to portions of text containing, for example, numeric dates, product names, technical descriptions, and expressions of strategic intent. As a result, the system can achieve higher recall and precision for specific categories of competitive information than conventional keyword-based extraction or manual note-taking.

The server, in some embodiments, applies additional non-conventional rules before and after inference. For example, the server can apply a rule-based filter that scans the generated summary to verify that at least one element in each target category (business policy, provision target, technical feature, implementation timing) is present. If a category is missing, the server can selectively adjust the prompt sentence to emphasize the missing category and re-issue an inference request, rather than relying on the user to identify deficiencies. This loop uses explicit technical criteria and automated control logic to guide iterative refinement, thereby reducing human workload and improving consistency. The server may also compute similarity measures between the generated summary and the original text using vector embeddings to detect abnormal summaries that deviate significantly from the source, and can flag such cases or automatically request a revised summary with a modified prompt. The terminal, in another embodiment, executes part of the preprocessing or analysis. The terminal may, for instance, run a local lightweight natural language processing model to detect document language, length, or structure before uploading to the server. The terminal can then send only relevant sections of very long documents to the server, such as sections identified as “Executive Summary” or “Product Overview,” thereby reducing network traffic and processing time. By distributing some steps to the terminal, the system reduces bandwidth consumption and server-side computation, improving scalability. The server, in turn, can be configured to handle multiple concurrent summarization requests from multiple terminals, with a scheduling component in the management module allocating model-inference slots based on priority and load.

In another embodiment, the server can use alternative generative AI models with different architectures, such as encoder-only or decoder-only transformer models, or recurrent neural network models with attention mechanisms, depending on resource constraints and performance requirements. The server can select among multiple models based on document length, domain, or sensitivity level, and can store which model was used for each summary. The server can also adjust model parameters such as number of layers, hidden dimension, or vocabulary size during deployment, provided that sufficient hardware resources such as graphics processing units or specialized accelerators are available. These variations allow the system to adapt to different computational environments while maintaining the fundamental data flow and prompt-based control logic.

In yet another embodiment, the server applies data augmentation techniques prior to training or fine-tuning a generative AI model used in the system. The server may paraphrase segments of competitor documents using back-translation, synonym replacement, or controlled perturbations, and may label them with structured summaries. The server may then use these augmented pairs to further fine-tune the model on competitive-intelligence tasks, optimizing a loss function tailored to summary coverage of specific categories. The server may weigh errors differently for missing business policy elements versus minor wording differences, thereby aligning the model more precisely with the system's objectives. This process improves the model's ability to respond to the system's prompt sentences, producing more reliable and technically relevant summaries.

Through these configurations and operations, the server, the terminal, and the user cooperate to implement a system that yields technical improvements over conventional document handling and analysis systems. The system reduces computational cost by optimizing text sequences and controlling inference behavior; increases accuracy and consistency of summaries by structuring prompts and enforcing category coverage; enhances data management by associating documents, prompts, models, and outputs in a unified storage structure; and reduces communication overhead by distributing preprocessing tasks and selectively uploading data. These technical effects arise from specific data structures, processing sequences, and model-control mechanisms within computing hardware, rather than from mere automation of a human workflow.

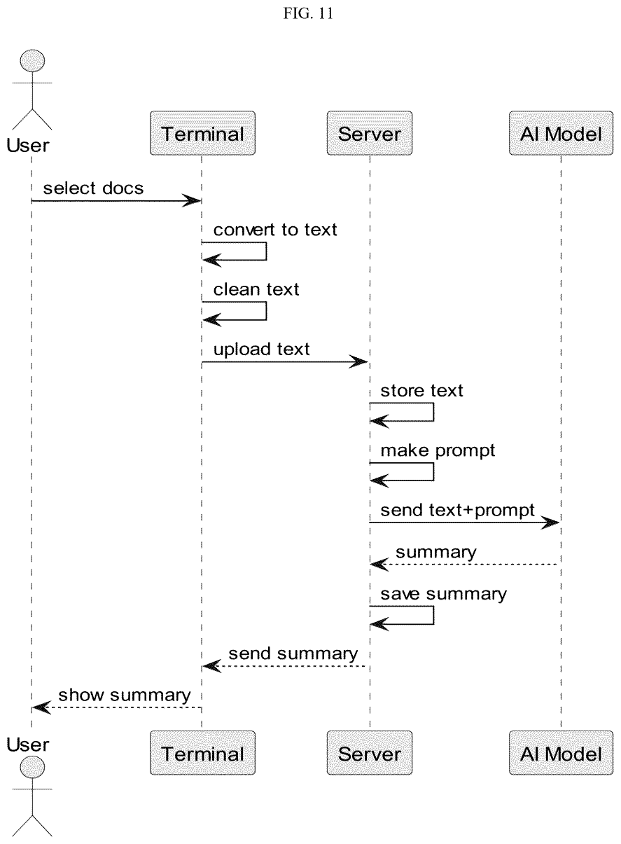

The following describes the processing flow using FIG. 11.

### Step 1

The user collects competitor documents.

The user uses the terminal to access external information sources via a web browser and an internal file manager. As input, the user has URLs of competitor websites, event portals, and locations of internal repositories. The user downloads press releases, presentation slides, white papers, and other documents in formats such as page-description files, word-processing files, and existing text files. As processing, the user instructs the terminal to save these files into a designated directory, optionally organizing them by date, competitor name, or project. As output, the terminal stores a set of raw competitor documents as electronic files in one or more folders.

### Step 2

The terminal converts heterogeneous documents into plain text.

The terminal uses a document-viewing or document-conversion application to open page-description files and word-processing files. As input, the terminal receives the raw competitor documents from Step 1. The terminal invokes an export or “Save as Text” function of the document-conversion application to convert each file into a plain text file. During data processing, the terminal extracts textual content while discarding layout objects such as images, page numbers, and headers where possible. As output, the terminal generates corresponding text files that contain character-based representations of the original documents.

### Step 3

The terminal cleans and normalizes the text files.

The terminal executes a script written in a programming language such as Python to preprocess the exported text. As input, the terminal reads the plain text files produced in Step 2. The terminal performs data processing operations including: removing unnecessary line breaks, deleting special symbols and non-printable characters, normalizing whitespace, and optionally merging multiple text files pertaining to the same competitor or event into a single text sequence. The terminal may, for example, replace repeated newline characters with spaces, remove extraneous tab characters, and filter out decorative symbols. As output, the terminal produces cleaned text files or text buffers that contain normalized character information suitable for downstream natural language processing.

### Step 4

The terminal transmits cleaned text to the server via secure communication.

The terminal uses a network interface and an HTTP client to send the preprocessed data to the server. As input, the terminal takes the cleaned text produced in Step 3 along with metadata such as document identifiers, file names, and timestamps. The terminal packages this information into a request body, typically in a structured format such as a JSON object, and attaches authentication credentials in the headers. The terminal establishes an encrypted channel using a protocol such as HTTPS and sends the request to an API endpoint hosted by the server. As data processing, the terminal serializes the text and metadata and handles any necessary chunking for large payloads. As output, the server receives the cleaned text data and metadata, and the terminal receives a response indicating successful receipt or an error status.

### Step 5

The server stores the received text and metadata.

The server uses a web application module and a database interface to manage incoming data. As input, the server receives the cleaned text and associated metadata from Step 4. The server validates authentication tokens, checks request formats, and verifies that the text size and character encoding are acceptable. The server then inserts records into a storage system, such as a relational database or document store, associating each document's text with a document identifier, user identifier, upload time, and an initial processing state such as “pending summarization.” As data processing, the server allocates primary keys, normalizes metadata fields, and writes the text into appropriate tables or storage objects. As output, the server maintains persistent records of the documents ready for further analysis and sends a confirmation message back to the terminal or user.

### Step 6

The server selects documents for summarization and prepares analysis inputs.

The server runs a background job or scheduled task that scans for documents requiring summarization. As input, the server reads from the storage system all records whose processing state is “pending summarization.” The server may filter by priority, user, or upload time. For each selected record, the server loads the cleaned text and relevant metadata into memory. The server may perform additional processing such as splitting very long texts into segments based on length or structural markers (for example, section headings). As data processing, the server creates internal data structures that hold text segments, identifiers, and control flags for summarization. As output, the server produces a queue or list of text segments and metadata entries ready to be processed by the generative AI model.

### Step 7

The server analyzes the text to determine summarization viewpoints and output constraints. The server uses a natural language processing engine to inspect the text before constructing prompt sentences. As input, the server takes a text segment and its associated metadata from Step 6. The server applies operations such as keyword detection, simple part-of-speech tagging, and frequency analysis to estimate document type (for example, press release, technical white paper, product announcement) and main topics. The server then maps these characteristics to predefined summarization viewpoints (such as business policy, provision target, technical feature, implementation timing) and preferred output formats (for example, bullet points, paragraph summary, or fixed length). As data processing, the server assigns a set of flags or labels indicating which categories must be covered in the summary and how the output should be structured. As output, the server obtains a configuration object that specifies the intended focus and format for the summary of the given text segment.

### Step 8

The server generates a structured prompt sentence.

The server uses the analysis module to construct a prompt sentence that encodes the configuration derived in Step 7. As input, the server receives the text segment and the configuration object specifying viewpoints and output constraints. The server selects a prompt template from a library and fills in placeholders to emphasize the required categories. The server may, for example, generate a prompt sentence such as:

“Summarize the following competitor document focusing on business strategy, main products, target customers, and planned release schedule. Provide the summary in bullet points.”or

“You are a professional market analyst. Read the following text and create a concise summary that highlights the competitor's product features, technical differentiators, target segments, and timeline for implementation.”or

“Summarize the following presentation in about 300 words. Focus on new products, key technologies, differentiation points, and market positioning.”

As data processing, the server concatenates the prompt sentence with separators and the text segment itself, forming a single query string or a structured message sequence for the generative AI model. As output, the server obtains inquiry information that includes both the prompt sentence and the text content, ready for transmission to the external model.

### Step 9

The server sends inquiry information to the generative AI model on an external processing apparatus.

The server uses the communication module and an API client to call a remote inference service. As input, the server uses the inquiry information from Step 8 and additional parameters such as model identifier, maximum output length, temperature, and decoding strategy. The server encodes this information into a request payload and sets headers including authentication keys. The server establishes an encrypted connection to the external processing apparatus and sends the payload to the generative AI model endpoint. As data processing, the server may compress the payload, handle retry logic, and ensure the sequence obeys token limits by truncating or chunking the text. As output, the external processing apparatus receives the query and begins inference, and the server awaits a response containing generated summary text.

### Step 10

The server receives and parses the response from the generative AI model.

The server obtains the result of model inference from the external processing apparatus. As input, the server receives a response message that includes the generated summary and metadata such as token counts and status codes. The server verifies the status, checks for errors, and extracts the summary content from the response. As data processing, the server may trim leading and trailing whitespace, normalize line breaks, and perform simple checks such as ensuring minimum length or presence of required categories. The server may also log diagnostic information such as processing time and number of tokens consumed. As output, the server produces a cleaned summary string associated with the original text segment and its document identifier.

### Step 11

The server validates coverage of required information categories.

The server evaluates whether the generated summary sufficiently covers the intended viewpoints. As input, the server uses the summary string from Step 10 and the configuration object from Step 7 specifying categories such as business policy, provision target, technical feature, and implementation timing. The server applies heuristic or rule-based checks, such as searching for temporal expressions (dates, quarters, years), terms indicative of targets (for example, “for small businesses,” “for enterprise customers”), and technical descriptors (for example, “algorithm,” “architecture,” “protocol”). As data processing, the server determines whether each category is represented in the summary and flags any missing categories. If coverage is insufficient, the server may modify the prompt sentence to emphasize missing categories and re-execute Steps 8 through 10 for that text segment. As output, the server produces a validated summary that satisfies predefined coverage criteria or a status indicating that refinement is needed.

### Step 12

The server stores the summary and associated metadata.

The server uses the management module to update records in the storage system. As input, the server takes the validated summary from Step 11, the original document identifier, the prompt sentence used, and information about the generative AI model such as model name and version. The server updates database entries to store the summary text, change the processing state from “pending summarization” to “completed,” and save the prompt sentence and model identifier for traceability. As data processing, the server writes the summary into a summary field or related table, indexes it by document identifier and timestamp, and logs any warnings or anomalies encountered during processing. As output, the server maintains a persistent and searchable association between the input document, the configuration, the prompt sentence, the generative AI model used, and the resulting summary.

### Step 13

The server prepares the summary for delivery to the terminal.

The server formats the summary and its context for presentation. As input, the server reads from storage the summary, document metadata (such as title, source, upload time), and optional system-generated indicators (such as processing duration or token counts). The server then prepares a response object or message content compatible with the chosen delivery channel. As data processing, the server may generate an email body including headings and bullet points, assemble a web page component with labeled sections, or structure a data payload for a programmatic interface. The server may also apply layout rules, such as truncating overly long summaries for on-screen display while keeping the full version in storage. As output, the server generates a formatted result ready to be transmitted to the terminal.

### Step 14

The server transmits the summary and metadata to the terminal.

The server uses its network interface and application logic to send the formatted result to the user. As input, the server uses the formatted summary content from Step 13 and the destination information, such as the user's email address or an active session identifier for a web client. The server sends the data via an electronic communication protocol appropriate to the channel: for example, an email protocol for email, or HTTPS for a web-based interface. As data processing, the server handles queueing, error retries, and encryption of the outgoing data. As output, the terminal receives a message or response containing the summary and the related document information.

### Step 15

The terminal displays the summary to the user.

The terminal uses its user interface components to present the received information. As input, the terminal obtains an email message, a web response, or an API response from the server in Step 14. The terminal parses the message content and renders the summary, document title, and any indicators such as processing time or model version in a graphical user interface. As data processing, the terminal may adapt text layout to the device display, allow scrolling, and highlight key sections such as bullet points or headings. As output, the user sees an organized summary of the competitor document on the terminal screen and can read or further process the information.

### Step 16

The user utilizes the summary for further analysis.

The user interacts with the terminal to interpret and act on the summarized information. As input, the user reads the summary and optionally inspects associated metadata such as competitor name, document date, and coverage categories. The user may copy portions of the summary into internal reports, annotate key findings in other software tools, or initiate additional requests for summaries of related documents. As data processing, the user may direct the terminal to send feedback to the server, such as rating the usefulness of the summary or specifying additional aspects to highlight in future summaries. As output, the system completes one summarization cycle and may update configuration parameters or logs for improving subsequent processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for monitoring information provision activities of other organizations, such as competitors, typically rely on rule-based scraping, keyword filters, and static templates for analysis and notification. These systems suffer from several technical limitations in terms of data acquisition, data normalization, large-scale text processing, and adaptive notification control.

First, when acquiring structured data or unstructured data from heterogeneous information sources over a network, conventional systems are not able to reliably normalize diverse document structures into machine-processable natural language text data. As a result, markup elements, layout artifacts, and irrelevant advertising content are often retained in the processed data, which degrades the accuracy and efficiency of downstream natural language analysis and increases unnecessary consumption of processor time and memory.

Second, conventional systems typically lack an efficient mechanism to distinguish new or updated information provision activities from previously processed content at scale. Without content-based identification and comparison, the same or similar information may be redundantly reprocessed and resent, leading to unnecessary invocation of external machine learning services, increased network traffic, and latency in delivering truly new information to user terminals.

Third, even when a generative AI model is used for text analysis, conventional systems often rely on fixed or manually crafted prompt sentences. Such static prompts are not adapted to the attributes of the input data, such as length, source type, or relevance feedback. Consequently, the generative AI model may produce summaries that are either too coarse or too detailed, omit important attributes, or fail to provide output in a format that can be efficiently post-processed by a computer. This results in suboptimal utilization of the computational resources of the generative AI model and reduces the overall throughput and responsiveness of the system.

Fourth, conventional systems generally do not provide a technical framework for organizing and comparing multiple generated summaries using both natural language processing technology and statistical processing technology, in a way that allows a processor to automatically compute trends and differences across many information provision activities. As a result, human operators must manually aggregate and interpret multiple summaries, which leads to inefficiencies and limits scalability.

Fifth, notification mechanisms in conventional systems are typically based on simple triggers and do not incorporate user-provided evaluation signals to refine future summarization and notification behavior. Without integrating importance evaluation information or relevance evaluation information into the control logic of the processor, the system cannot adaptively learn which types of information and which summary formats are most useful to users. This causes repeated delivery of low-value notifications, unnecessary use of network bandwidth and device resources, and slower access to high-value information.

Accordingly, there is a need for an improved computer-implemented system that: (i) robustly normalizes heterogeneous web and database content into natural language text data; (ii) performs content-based identification to limit processing to new or updated information; (iii) dynamically generates and updates prompt sentences for a generative AI model based on data attributes and past evaluation; (iv) automatically organizes and compares generated summaries to compute machine-usable trend and difference data; and (v) adaptively controls notification selection and content based on user feedback. Such a system should improve the overall efficiency, accuracy, and scalability of the underlying computer technology used for large-scale monitoring and analysis of information provision activities.

The specific processing by the specific processing unit 290 of the data processing device 12 in Application Example 1 is realized by the following means.

The present invention provides a server comprising a processor and a storage device, the processor being configured to acquire, via a communication network or from an information storage device, structured data or unstructured data related to information provision activities of other organizations from a plurality of information sources; to extract, from the acquired data, predetermined structural information and remove display structure elements and advertisement elements to normalize the acquired data as natural language text data; to generate content-based identification information for the natural language text data, compare the identification information with identification information of previously processed data stored in the storage device, determine whether an information provision activity corresponding to the natural language text data is new or updated, and select only new or updated information provision activities as targets for subsequent processing; to dynamically generate, in accordance with attribute information and a content type of the selected natural language text data, a prompt sentence that specifies summarization conditions, extraction items, and output format for a generative AI model, and to structure input data including the prompt sentence and the natural language text data into a format acceptable by the generative AI model; to transmit, via the communication network, the input data to the generative AI model, receive a summary text and feature information generated in accordance with the prompt sentence from the generative AI model, and store the summary text and the feature information in the storage device; to classify a plurality of the summary texts and the feature information by at least one of an organization unit, a product or service category unit, and a time unit, and to generate organized result data indicating trends and differences of a plurality of information provision activities by performing comparison and organization using natural language processing technology and statistical processing technology; to select, as notification targets, at least one of the organized result data and the summary texts that satisfy a predetermined condition, generate notification data including notification title information and notification body information, and transmit the notification data to a user terminal via a message delivery service or a notification delivery device; to receive, from the user terminal, importance evaluation information or relevance evaluation information input by a user in response to the displayed summary text and organized result data; and to update, based on the evaluation information, at least one of the summarization conditions, the extraction items, and selection conditions for the notification targets used in generating the prompt sentence and in selecting the notification targets. This enables the computer system to reduce redundant processing of already-processed content, to adapt the behavior of the generative AI model through dynamically generated prompt sentences, to automatically compute and store trend and difference data across multiple information provision activities, and to optimize notification selection and content based on user feedback, thereby improving the efficiency, scalability, and responsiveness of the underlying computer technology for large-scale monitoring and analysis of external information provision activities.

The term “system” refers to a combination of one or more hardware devices and software components that cooperate to perform data acquisition, processing, storage, communication, and presentation functions.

The term “processor” refers to a hardware processing unit, such as a central processing unit or a processing core, that executes instructions to perform logical, arithmetic, control, and input/output operations.

The term “storage device” refers to a hardware memory component, such as a magnetic storage, optical storage, or semiconductor memory, configured to store data, programs, and intermediate processing results.

The term “communication network” refers to any wired or wireless data communication infrastructure, including the Internet, local area networks, wide area networks, and mobile communication networks, over which digital data can be transmitted and received.

The term “information storage device” refers to a computing resource, such as a database server, file server, or cloud storage service, that stores and provides access to digital information.

The term “information source” refers to an origin of data, such as a website, application programming interface, database, or electronic document repository, from which structured data or unstructured data can be obtained.

The term “information provision activity” refers to an act of publishing or distributing information by an organization, including but not limited to announcements, public communications, press releases, event notices, marketing materials, and similar communications.

The term “structured data” refers to data that is organized according to a predefined schema or format, such as tabular data, markup language with explicit tags, or records in a database.

The term “unstructured data” refers to data that does not conform to a predefined schema or tabular structure, including natural language text, free-form documents, web pages, and similar data.

The term “natural language text data” refers to text represented in a human language, such as sentences or paragraphs, that has been extracted or normalized from one or more data sources and is suitable for natural language processing.

The term “display structure element” refers to a data component used primarily for visual layout or presentation, such as navigation menus, headers, footers, sidebars, or style-related markup, that does not represent substantive content of an information provision activity.

The term “advertisement element” refers to a data component indicating advertising content, promotional banners, sponsored links, or similar marketing elements that are not part of the core informational content to be analyzed.

The term “content-based identification information” refers to information derived from the content of text, such as hash values, signatures, or feature vectors, that enables determination of whether two pieces of content are the same or have changed.

The term “attribute information” refers to metadata or descriptive information associated with data, such as source type, organization, category, timestamp, language, or content length.

The term “content type” refers to a classification of text according to its nature or purpose, such as a product announcement, event notice, policy update, or marketing message.

The term “prompt sentence” refers to a sequence of natural language instructions or queries provided as input to a generative AI model to guide the model's processing and output format.

The term “summarization condition” refers to a rule or parameter that specifies how a summary is to be generated, including desired length, level of detail, focus topics, or style.

The term “extraction item” refers to a type of information to be explicitly extracted or highlighted by the generative AI model, such as product features, target market, pricing, positioning, or competitive advantages.

The term “output format” refers to a specification of the structure or representation of the generated output, such as bullet points, numbered lists, paragraphs, tables, or labeled sections.

The term “generative AI model” refers to a machine learning model, such as a neural network-based language model, configured to generate text or other data in response to input data and instructions.

The term “input data” refers to data transmitted to the generative AI model, including at least a prompt sentence and natural language text data, and optionally additional parameters or context.

The term “summary text” refers to text generated by the generative AI model that represents a condensed version of original content according to one or more summarization conditions.

The term “feature information” refers to additional data generated or derived from the original content, such as extracted attributes, keywords, topics, categories, or other structured descriptors.

The term “organized result data” refers to data representing classification, comparison, aggregation, or analysis of multiple summary texts and feature information, including trends, differences, and relationships among information provision activities.

The term “natural language processing technology” refers to computational techniques and algorithms for analyzing, understanding, or generating human language, such as tokenization, part-of-speech tagging, named entity recognition, topic modeling, and text classification.

The term “statistical processing technology” refers to computational methods based on probability and statistics, such as clustering, regression, frequency analysis, and distribution analysis, applied to numerical or categorical data.

The term “organization unit” refers to a classification dimension corresponding to an organization, such as a company, division, group, or other entity responsible for an information provision activity.

The term “product or service category unit” refers to a classification dimension identifying a group of products or services that share similar functions or markets.

The term “time unit” refers to a segmentation of time, such as a day, week, month, quarter, or year, used to group or compare information provision activities.

The term “notification target” refers to any summary text or organized result data selected by the processor to be transmitted to a user terminal as part of a notification.

The term “notification data” refers to data prepared for delivery to a user terminal, including at least notification title information, notification body information, and optionally identifiers or links to related content.

The term “notification title information” refers to text or symbols indicating a title or subject line of a notification presented to a user.

The term “notification body information” refers to text or symbols indicating main content of a notification, such as a short description or key points.

The term “message delivery service” refers to a communication service that routes and delivers messages or notifications from a server to user terminals over a communication network.

The term “notification delivery device” refers to a hardware or software component configured to send, relay, or manage notifications between a server and user terminals.

The term “user terminal” refers to an end-user device, such as a smartphone, tablet, personal computer, or similar computing device, capable of receiving, processing, and displaying notification data.

The term “importance evaluation information” refers to data indicating a user's assessment of the importance or priority of displayed content, such as ratings, flags, or labels.

The term “relevance evaluation information” refers to data indicating a user's assessment of how relevant displayed content is to the user's interests or tasks.

The term “evaluation information” refers to one or both of importance evaluation information and relevance evaluation information provided by a user.

The term “trend” refers to a pattern or directional change over time in information provision activities, such as increasing frequency of a topic or shift in target market.

The term “difference” refers to a distinction or variation between information provision activities, such as differences in features, pricing, targets, or messaging among organizations.

The term “own organization” refers to an entity operating the system or on whose behalf the system is operated, and whose competitive position or information provision activities may be analyzed relative to other organizations.

The term “analysis information” refers to information generated by the processor that interprets or evaluates relationships among attributes, including indications of advantages, disadvantages, or differentiation factors.

In one embodiment, a server, one or more terminals, and a communication network together implement the claimed system. The server includes at least one processor, a main memory, and a non-transitory storage device such as a magnetic disk or solid-state drive. The processor executes software modules stored on the storage device, including a web acquisition module, a text normalization module, a content identification module, a prompt generation module, a generative AI interface module, an organization and comparison module, a notification control module, and a feedback adaptation module. The terminal includes a processor, a memory, a display device such as a liquid crystal display or organic light-emitting diode display, a network interface, and an input unit such as a touch panel. The server uses a general-purpose operating system, for example a Linux-based system, and an application runtime such as a Python interpreter or a Java virtual machine. The web acquisition module uses HTTP client libraries (for example, a requests-type library) and an HTML parsing library (for example, a BeautifulSoup-type library) to obtain and parse electronic documents. The generative AI interface module communicates with a generative AI model that is implemented as a transformer-based neural network running on an external computation platform. In one example, the generative AI model conforms to the architecture of a GPT-3.5-type model, which includes multiple self-attention layers, feed-forward networks, and positional encoding components, trained on large-scale text corpora using a variation of stochastic gradient descent to minimize a cross-entropy loss function. The server stores data in a relational database system, for example a PostgreSQL-type database, and optionally in an in-memory key-value storage system similar to Redis for caching. The server holds tables for organization information, source information, raw document records, normalized text records, summary records, feature records, and user evaluation records. Each record includes indexed fields such as source URL, organization identifier, hash value of normalized text, timestamp, and classification attributes. By designing these specific data structures and indexes, the server reduces disk access overhead and improves query speed in large-scale deployments.

The server acquires structured data and unstructured data by sending HTTP requests or database queries to information sources such as web servers, content management systems, or external data repositories. The server parses received documents into a document object model and programmatically removes display structure elements and advertisement elements by matching HTML tags and class attributes to patterns stored in configuration data. The server converts the remaining content into natural language text data, normalizes character encodings, removes markup symbols, and performs tokenization and sentence segmentation using a natural language processing library. This concrete normalization process reduces noise and ensures that the token sequence provided to the generative AI model contains only semantically relevant content, which improves the accuracy of summarization and reduces unnecessary token processing, thereby decreasing latency and computation cost.

The server generates content-based identification information by calculating a hash value, for example using a SHA-256-type hashing algorithm, over the normalized text data. The server stores this hash in association with the source URL and timestamp. When the server later acquires data from the same source, the server calculates a new hash and compares it with stored hashes to determine whether the content is new or updated. The server may also derive additional identification information such as a minhash signature or a feature vector obtained from a term frequency-inverse document frequency (TF-IDF) representation. By performing such content-based comparison, the server avoids repeatedly sending identical or nearly identical documents to the generative AI model. This reduces the number of API calls, lowers network bandwidth usage, and reduces monetary and computational cost, which constitutes an improvement in the efficiency and scalability of the computer system.

The server generates a prompt sentence for each selected piece of natural language text data. The server uses the prompt generation module to analyze attribute information such as the text length, the type of acquisition source (for example, press announcement page, technical article, or product catalog), the organization identifier, and past user evaluation information. The server uses these attributes as input to a rule-based engine or a small auxiliary model to determine summarization conditions, including target summary length, required extraction items, preferred output format, and level of technical detail.

In one embodiment, the server constructs a prompt sentence such as:

“Please summarize the following competitor announcement. Extract and list: (1) the main product or service, (2) key features, (3) target customers, and (4) pricing or positioning. Text: [announcement text].”

In another embodiment, the server constructs a prompt sentence such as:

“Read the following press release and provide: (a) a three-sentence summary, (b) three bullet points describing the main features, (c) the target market, and (d) any explicit pricing or positioning statements. Text: [press release text].”

In still another embodiment, the server constructs a prompt sentence that emphasizes analysis of competitive advantages:

“Read the following competitor press release and provide: 1) a concise summary in 3-5 bullet points, 2) the competitive advantages claimed by the competitor, and 3) potential implications for our organization's product positioning and pricing. Text: [press release text].”

The server assembles the prompt sentence and the normalized text into a structured input message in accordance with the interface specification of the generative AI model, and transmits the message over a secure communication channel such as HTTPS. The generative AI model, implemented as a multi-layer transformer network with self-attention mechanisms, internally converts the input text into token embeddings, applies multi-head self-attention to compute contextualized representations, and generates an output token sequence by sequentially sampling from a probability distribution over the vocabulary. The generative AI model uses parameters (weights and biases) that have been trained on a large corpus of text, and during training the model has minimized a loss function, such as cross-entropy between predicted tokens and ground-truth tokens, using a gradient-based optimizer. In some embodiments, the model has been fine-tuned on task-specific documents so that it more reliably extracts product features, target markets, and pricing terms.

The server receives an output message from the generative AI model and extracts a summary text and feature information, which may include structured items such as lists of features, identified target segments, pricing ranges, and key claims. The server stores this data in the database using predefined schemas. The server may further process the summary text by applying additional natural language processing, such as named entity recognition to identify product names and organization names, or topic modeling to associate topics with each summary. The server can also compute vector representations (embeddings) of summary texts using a separate embedding model, enabling fast similarity search and clustering. The server organizes and compares multiple summaries by grouping them based on organization unit, product or service category, and time unit. The server uses statistical processing techniques such as frequency counting, trend analysis, and clustering to derive organized result data. For example, the server may count occurrences of specific technical terms in summaries over a quarterly time unit to determine whether competitors are increasingly emphasizing “cloud-based analytics” or “edge computing.” By computing these trend statistics automatically and maintaining them in indexed tables, the server enables rapid query and visualization, reducing the need for manual aggregation and improving the responsiveness of the analysis process.

The server selects notification targets based on predetermined rules and dynamically learned criteria. The server maintains configuration data that associates certain conditions (for example, detection of a new product launch, change in price, or entry into a new target market) with notification priority levels. The server examines feature information and organized result data to determine whether a new summary meets any condition. The server also uses user evaluation information to refine these selection rules. By filtering notifications at the server side using structured feature information and statistical thresholds, the server reduces the volume of notifications transmitted over the network, thereby decreasing communication load and improving user experience on terminals.

The server generates notification data including notification title information and notification body information. In one example, the server constructs a title such as “Competitor A: New AI analytics platform for mid-sized retailers,” and a body such as “Key features: cloud-based dashboard, CRM integration, subscription starting at $99 per month.” The server transmits this notification data to the terminal through a message delivery service, for example a push notification service similar to Firebase Cloud Messaging, using device tokens or topic identifiers to address specific terminals or groups of terminals.

The terminal receives the notification data through its network interface and operating system notification subsystem. The terminal displays the notification as a banner, lock-screen message, or status icon. When the user selects the notification, the terminal launches an application that sends a request to the server for the corresponding detailed summary and organized result data. The terminal uses its graphical user interface framework, such as a native user interface toolkit, to render screens that show the summary text, key extracted items (features, target market, pricing), and trend indicators. The terminal may provide filters and sorting options that cause the terminal to request specific subsets of data from the server. The user interacts with the terminal by scrolling through lists of summaries, opening detailed views, and entering evaluation information. The user indicates importance evaluation information or relevance evaluation information, for example by selecting “high importance,” “moderate importance,” or “low importance,” or by rating content on a numerical scale. The terminal collects this input and transmits evaluation records to the server. The server stores the evaluation information in association with the corresponding summary and feature information, and uses it to adjust the parameters of the prompt generation module and notification control module.

In one embodiment, the server uses the evaluation information to modify rule parameters that determine summarization conditions. For example, if users frequently mark summaries as “too long” for certain source types, the server reduces the target summary length for those sources. If users mark pricing-related content as highly important, the server updates the prompt generation rules to explicitly request more detailed pricing information in the prompt sentence for future documents of similar type. This feedback-driven adaptation leads to more relevant and concise summaries and reduces the amount of unnecessary text processed and displayed, which in turn improves computation and communication efficiency. In another embodiment, the server maintains a smaller auxiliary model, such as a logistic regression classifier or a lightweight neural network, that predicts summary length and extraction item importance based on past evaluation data. The server updates the model parameters using a supervised learning procedure whenever new evaluation information is received. By updating this model, the server gradually refines how it generates prompt sentences so that the generative AI model produces output that better matches user expectations and technical constraints, such as device display size and network bandwidth. The server thereby achieves technical improvements over conventional systems. By performing content-based identification before invoking the generative AI model, the server reduces redundant calls and lowers the overall number of tokens processed. This directly reduces processor time and network usage, which is a technical improvement in resource efficiency. By normalizing heterogeneous documents into a consistent natural language text representation and removing noise elements, the server improves the signal-to-noise ratio of the input data, allowing the generative AI model to produce more accurate summaries and reducing post-processing errors. By dynamically generating and updating prompt sentences based on context and feedback, the server tailors the generative AI model's behavior in a way that optimizes output for machine consumption, improving both accuracy and computational efficiency.

The use of a transformer-based generative AI model in this system is not a mere automation of human summarization. The model processes high-dimensional token embeddings and captures long-range dependencies that human operators cannot systematically handle at scale. The server exploits specific internal properties of such a model—namely, its ability to condition on complex prompt sequences—to control the structure and content of the generated summary in ways that facilitate subsequent machine processing, such as automatic extraction of fields and trend computation. This architecture and the feedback-based prompt adaptation are non-conventional uses of generative AI technology that enhance the underlying computer system.

Alternative embodiments are possible. The server may use a different neural network architecture, such as an encoder-decoder model, with similar prompt-based conditioning. The server may integrate an on-premise generative model running on graphical processing units, instead of or in addition to a remote cloud-based model, while maintaining the same data structures and prompt generation mechanisms. The server may also use different hashing algorithms or similarity metrics for content-based identification, such as locality-sensitive hashing or cosine similarity on document embeddings. The specific choice of libraries (for example, different HTTP clients or different NLP toolkits) may vary without departing from the essence of the system.

In all such embodiments, the server, the terminal, and the generative AI model cooperate through clearly defined data structures and control flows. By combining structured normalization, content-based deduplication, adaptive prompt generation, transformer-based generative summarization, statistical organization, and feedback-driven control, the system provides an improved computer-implemented technique for large-scale acquisition, analysis, and presentation of external information provision activities, achieving measurable gains in speed, precision, and resource utilization.

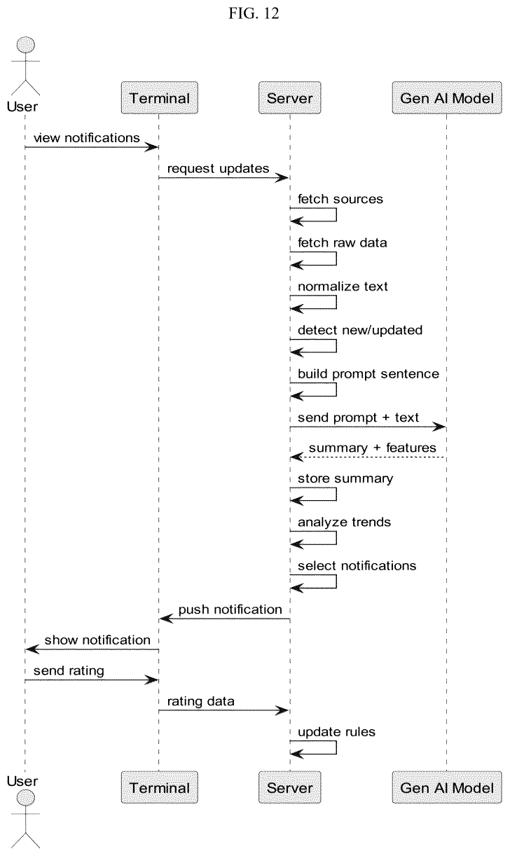

The following describes the processing flow using FIG. 12.

### Step 1

The server acquires raw data related to information provision activities of other organizations.

The input is a set of source definitions stored in a database, including URLs, API endpoints, and query parameters.

The server sends HTTP requests or database queries to these sources using a network interface, receives structured or unstructured data such as HTML pages, JSON records, or text files, and stores the raw responses in a storage device.

The output is a collection of raw documents associated with organization identifiers, source identifiers, and timestamps.

### Step 2

The server normalizes the acquired raw data into natural language text data.

The input is the raw documents obtained in Step 1.

The server parses HTML or markup structures, removes display structure elements such as headers, footers, navigation menus, and advertisement elements based on preconfigured tag patterns, and extracts the main content region.

The server converts the extracted content to plain text, normalizes character encodings, removes markup tags and extraneous whitespace, and performs basic linguistic preprocessing such as sentence splitting and tokenization.

The output is normalized natural language text data with associated metadata (source URL, organization identifier, acquisition time).

### Step 3

The server generates content-based identification information and detects new or updated information.

The input is the normalized natural language text data from Step 2.

The server computes a content hash value, for example using a SHA-256-type hashing algorithm, or generates a text signature based on a TF-IDF vector or similar feature representation.

The server compares the new identification information with previously stored identification information for the same source, and determines whether the content is new, updated, or unchanged.

The server selects only the records classified as new or updated for further processing.

The output is a filtered set of normalized text records flagged as new or updated, along with their identification information.

### Step 4

The server determines summarization conditions and extraction items based on attributes of the selected text.

The input is the filtered set of normalized text records and their metadata from Step 3.

The server analyzes attributes such as text length, source type, organization identifier, and time of acquisition.

The server may apply a rule-based engine or a lightweight model to map these attributes to summarization parameters, including desired summary length, required extraction items (for example, features, target market, pricing), and target output format (for example, bullet list or paragraph).

The output is, for each selected text record, a set of summarization parameters that define how the generative AI model should process the text.

### Step 5

The server generates a prompt sentence for the generative AI model.

The input is the normalized natural language text and the summarization parameters from Step 4.

The server constructs a natural language instruction string that encodes the summarization conditions and extraction items.

For example, the server may generate a prompt sentence such as:

“Please summarize the following competitor announcement. Extract and list: (1) the main product or service, (2) key features, (3) target customers, and (4) pricing or positioning. Text: [announcement text].”

The server embeds the normalized text into the prompt after the “Text:” label or a similar delimiter.

The output is a complete prompt sentence associated with the original text and ready to be sent to the generative AI model.

### Step 6

The server prepares and sends input data to the generative AI model.

The input is the prompt sentence and associated normalized text from Step 5.

The server structures this information into a request message according to the API specification of the generative AI model, including model name, prompt content, maximum token count, and temperature parameters.

The server transmits the request message to the generative AI model over a secure communication channel, such as HTTPS.

The output is a pending request in transit and, after completion, a response message containing generated text from the generative AI model.

### Step 7

The server receives and parses the output from the generative AI model.

The input is the response message returned in Step 6.

The server extracts the generated text content from the response fields, separates the summary text and any explicitly structured feature information if the prompt requested structured output, and validates the format and completeness of the response.

If an error or timeout occurs, the server logs the event and may retry the request according to predefined retry rules.

The output is a validated summary text and associated feature information for each processed document.

### Step 8

The server stores the summary text and feature information in structured data records.

The input is the summary text and feature information from Step 7 together with the original metadata (organization, source, timestamp, identification information).

The server inserts or updates records in database tables dedicated to summaries and features, indexing them by organization, category, and time.

The server may also compute and store additional representations, such as numeric embeddings or keyword lists, derived from the summary text using local NLP libraries.

The output is a persistent set of summary records and feature records, accessible for later querying and analysis.

### Step 9

The server organizes and compares multiple summaries to generate organized result data. The input is the collection of summary and feature records stored in Step 8.

The server groups summaries by organization, product or service category, and time unit, and applies natural language processing and statistical processing techniques such as keyword frequency analysis, topic clustering, or trend detection.

The server calculates trends, such as increasing appearances of certain features, and differences, such as divergent pricing strategies among organizations.

The output is organized result data that explicitly describes trends and differences in information provision activities across organizations and time.

### Step 10

The server selects notification targets based on organized result data and summary attributes. The input is the organized result data from Step 9, the underlying summary records, and configuration rules including thresholds and conditions for notifications.

The server evaluates each summary and each segment of organized result data against predetermined conditions, such as detection of a new product launch, changes in target market, or significant pricing modifications.

The server flags items that satisfy the conditions as notification targets.

The output is a set of selected summaries and organized result records marked as notification targets with associated priority levels.

### Step 11

The server generates notification data and transmits it to the terminal.

The input is the set of notification targets from Step 10.

The server constructs notification title information and notification body information, typically using concise text extracted from or derived from the summary and organized result data.

The server encapsulates this information into notification messages addressed to specific user terminals using identifiers such as device tokens or user IDs, and sends the messages via a message delivery service or notification delivery device over the communication network. The output is a sequence of notification messages dispatched to terminals.

### Step 12

The terminal receives and displays notification data to the user.

The input is the notification message delivered in Step 11.

The terminal's operating system and application retrieve the notification title and body, display them on the screen as a banner, alert, or lock-screen message, and associate each notification with a deep link or identifier pointing to detailed data on the server.

When the user selects a notification, the terminal sends a data request to the server for the full summary and related organized result data and then renders a detailed view on the display. The output is a visual presentation of the summary and analysis content to the user.

### Step 13

The user reviews the displayed content and provides evaluation information.

The input is the summary text and organized result data presented on the terminal in Step 12. The user operates input controls, such as buttons, sliders, or rating widgets, to indicate importance evaluation information and relevance evaluation information, for example by marking an item as “high importance” or assigning a relevance score.

The terminal records the user's selections and transmits structured evaluation data back to the server, including references to the corresponding summary or organized result data.

The output is a set of evaluation records delivered from the terminal to the server.

### Step 14

The server updates prompt generation and notification control based on evaluation information.

The input is the evaluation records received in Step 13 together with existing configuration parameters and historical evaluation data.

The server aggregates evaluation information per source type, organization, and content category, and adjusts summarization parameters used in Step 4 and Step 5, such as target summary length, emphasis on particular extraction items, and preferred output formats.

The server also modifies notification selection thresholds used in Step 10, for example increasing the priority for content types frequently marked as highly important and reducing notifications for content types often marked as low relevance.

The output is an updated set of internal parameters and rules that will influence subsequent content selection, prompt sentence generation, and notification behavior.

### Step 15

The server uses the updated parameters in subsequent processing cycles to improve efficiency and relevance.

The input is new content acquired in later iterations together with the updated configuration derived in Step 14.

The server applies the refined summarization and notification rules to the new content, resulting in fewer redundant generative AI model calls, more concise and focused prompt sentences, and more selective notification delivery.

The output is an improved overall system behavior, characterized by reduced processing and communication overhead and increased relevance and usefulness of information presented to the user.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented competitive analysis systems generally require substantial manual configuration and rule engineering to extract and compare key aspects of information regarding different organizations. In many implementations, unstructured text is either processed by static keyword lists or by shallow statistical methods that are not adaptive to changes in domain terminology or user goals. As a result, such systems often fail to capture nuanced differences between entities, such as differences in user perception, product strengths and weaknesses, or strategic positioning, and instead produce coarse, noisy indicators that provide limited value.

Moreover, existing systems frequently separate text summarization, feature extraction, and visualization into loosely coupled modules that are not optimized to work together as an integrated pipeline. This separation can lead to duplicated processing, inconsistent intermediate representations, and increased latency, especially when operating on large volumes of text originating from multiple sources. In particular, conventional systems do not effectively exploit generative AI models to dynamically generate prompt sentences that control how unstructured data is summarized and analyzed, nor do they systematically reuse model outputs as structured intermediate data for downstream comparison and visualization. In addition, many known techniques are not well adapted to automatically generating machine-usable, structured feature information from generative AI model outputs. Typically, the results of generative models are consumed directly by human users as natural language text, without further automated transformation into normalized representations that can be efficiently processed by other algorithms. This limits the ability of computer systems to perform fine-grained, quantitative comparisons between multiple entities and to generate consistent visual artifacts, such as graphs, in an automated and scalable manner.

Further, conventional approaches tend to treat visualization as a separate, post-processing step, often carried out in external tools, which requires manual export and formatting of data. This fragmented workflow impedes real-time, end-to-end processing on a server and prevents the system from providing immediate, interactive visual comparison outputs to user terminals. As a consequence, users experience delays and friction when attempting to translate raw analysis into actionable insights.

Accordingly, there is a need for an improved computer-implemented technique that integrates generative AI models with deterministic natural language processing and visualization components in a unified server-side architecture. Such a technique should (i) normalize and structure unstructured text originating from multiple organizations, (ii) leverage dynamically generated prompt sentences to obtain targeted summaries from a generative AI model, (iii) convert the summaries into structured feature data through NLP-based extraction, (iv) compute quantitative comparison metrics between organizations, and (v) generate visual representations and explanation information in an automated manner. By doing so, the technique should improve the functioning of the computer system itself, enabling more efficient, accurate, and scalable generation of comparative analytical outputs that can be consumed directly by user terminals without additional manual processing.

The specific processing by the specific processing unit 290 of the data processing device 12 in Example 2 is realized by the following means.

The present invention provides a server comprising a processor configured to acquire character information regarding multiple organizations from a communication network or a storage device, convert the character information into normalized data, generate prompt sentences for a generative AI model based on the normalized data, obtain summary information from the generative AI model, transform the summary information into structured feature information via natural language processing that includes morphological analysis and frequency calculation, compute comparison information including occurrence degrees and difference indices between feature information for different organizations, generate image data representing the comparison information as graphs by using statistical processing and drawing libraries, and transmit the summary information, the comparison information, and the image data as display data to a user terminal. This enables the server to perform an integrated, computer-implemented pipeline that automatically converts unstructured multi-organization text into structured, comparable feature representations and visual artifacts, thereby improving the efficiency, scalability, and technical capability of the computer system to generate and deliver actionable comparative analysis without requiring manual rule engineering or external visualization tools.

The term “system” refers to a combination of one or more hardware components and one or more software components that cooperate to perform information processing, including at least a processor configured to execute instructions.

The term “processor” refers to one or more hardware circuits, such as a central processing unit, graphics processing unit, or specialized logic circuitry, configured to execute machine-readable instructions and perform arithmetic, logical, control, or input/output operations.

The term “character information” refers to data represented in a textual form, including symbols, letters, numbers, and punctuation, that can be interpreted as natural language or other symbolic language content.

The term “communication network” refers to a wired or wireless data transmission infrastructure that enables exchange of information between computing devices, including local area networks, wide area networks, and global networks.

The term “storage device” refers to a physical medium or component capable of storing digital data, including volatile and non-volatile memory, magnetic storage, and optical storage.

The term “machine-readable format” refers to a representation of data that can be directly processed by a computing device, such as encoded text, structured data, or serialized objects, without manual transcription.

The term “unnecessary information” refers to portions of data that are irrelevant, redundant, or noisy with respect to a target processing task, and that may be removed or filtered to improve processing accuracy or efficiency.

The term “normalized data” refers to data that has been transformed into a consistent, standardized representation, for example by unifying encoding, removing noise, and structuring content for subsequent processing.

The term “prompt sentence” refers to a textual instruction or query provided as input to a generative AI model to guide or control the model's generation or transformation of output data.

The term “generative AI model” refers to a machine learning model configured to generate or transform data, such as natural language text, in response to input data and prompt sentences, typically trained on large-scale datasets.

The term “summary information” refers to condensed textual content derived from original character information, in which main points, themes, or features are extracted and presented in a shorter form.

The term “natural language processing” refers to computational techniques and algorithms for analyzing, interpreting, transforming, or generating human language in a machine-processable manner.

The term “morphological analysis processing” refers to a natural language processing operation that segments text into smaller linguistic units, such as words or morphemes, and determines attributes such as part-of-speech.

The term “frequency calculation processing” refers to an operation that computes how often a given term, token, or feature appears within a specified dataset or text corpus.

The term “keyword” refers to a term or expression extracted from text that is considered salient or representative with respect to the content or a particular analysis objective.

The term “topic” refers to a concept, theme, or subject matter inferred or extracted from one or more pieces of text based on the distribution or semantics of terms.

The term “feature information” refers to structured data that represents characteristics, attributes, or properties extracted from text or other data sources, such as keywords, topics, or statistical measures.

The term “structured data” refers to data organized according to a predefined schema or format, such as key-value pairs, tables, or records, which enables systematic computer processing and querying.

The term “common elements” refers to features, keywords, or other units of information that appear in association with two or more different entities or datasets.

The term “different elements” refers to features, keywords, or other units of information that appear predominantly or exclusively in association with one entity or dataset compared to another.

The term “comparison information” refers to data that quantitatively or qualitatively describes relationships between feature information associated with different entities, including similarities and differences.

The term “occurrence degree” refers to a quantitative indicator, such as frequency or weight, representing how often or to what extent a specific feature appears in a dataset.

The term “difference index” refers to a calculated metric that represents the magnitude or direction of difference in a feature's occurrence degree between two or more entities or datasets.

The term “image information” refers to data representing a visual artifact, such as a graph or chart, which can be rendered on a display device to visually convey information.

The term “bar graph” refers to a type of chart that represents numerical values using bars of variable length or height, typically arranged along categorical axes.

The term “line graph” refers to a type of chart that represents numerical values as points connected by lines, typically used to show trends or relationships across an ordered axis.

The term “statistical processing program” refers to software that performs numerical or statistical operations, such as aggregation, calculation of frequencies, or derivation of indices, on structured data.

The term “drawing library” refers to a software component or collection of functions for generating visual representations, such as charts or diagrams, from data.

The term “display data” refers to data formatted for presentation on an output device, including layout, text, and image elements, which can be directly rendered by a user terminal.

The term “user terminal” refers to a computing device operated by a human user, such as a personal computer, tablet, or smartphone, configured to send requests to and receive responses from a server.

The term “refined summary” refers to summary information that has been further processed or generated to present key points in a more structured, concise, or organized format, such as a list of bullet points.

The term “emphasized elements” refers to features or keywords that exhibit relatively higher occurrence degrees or prominence for a particular entity compared to other entities.

The term “classification result” refers to data indicating assignment of features, keywords, or elements into categories or groups according to predetermined or learned criteria.

The term “explanatory information” refers to generated text that interprets, explains, or contextualizes analytical results, such as classification results or comparison information, for consumption by a user.

The term “analysis result” refers to the overall outcome of processing, including summary information, feature information, comparison information, and explanatory or visual information produced by the system.

In one embodiment, a server includes a hardware processor, a main memory, a non-volatile storage device, a network interface, and a display interface. The server executes a software stack that may include an operating system such as a general-purpose server operating system, a web application framework such as a server-side framework, a numerical computation library, a natural language processing library, and a plotting library. The server further accesses a generative AI model provided as an external service or as a locally deployed model.

The server stores program modules including a data acquisition module, a normalization module, a prompt generation module, a generative AI interaction module, a natural language processing module, a comparison computation module, a visualization module, and a response composition module. The server loads these modules into memory and executes them to realize the claimed functions. The modules cooperate through defined data structures, such as text buffers, token sequences, feature vectors, and key-value mappings.

The server communicates with one or more terminals operated by a user. A terminal includes a processor, memory, a display, user input devices, and a network interface. The terminal executes a browser or dedicated application to transmit input data to the server and to receive and present analysis results from the server. The user operates the terminal to select text sources, to initiate analysis, and to review summaries, comparison results, and visualizations. The server acquires character information including information regarding a first organization and information regarding a second organization. The server acquires this character information from a communication network, such as a wide area network, or from a storage device, such as a solid-state drive, depending on configuration. For example, the server acquires customer reviews, product descriptions, technical documents, or news articles regarding two different entities. The server reads the character information into text buffers in main memory and associates metadata, such as organization identifiers, language codes, and timestamps.

The server converts the acquired character information into normalized data. The server converts text encoding to a unified encoding such as UTF-8, removes invalid bytes, and standardizes whitespace and punctuation. The server performs language-dependent normalization, such as lowercasing alphabetic characters, normalizing full-width and half-width characters, and standardizing Unicode variants. The server applies noise removal rules, including removal of HTML tags, script segments, extraneous markup, and boilerplate. The server stores the normalized data as a sequence of characters in a structured data object that also holds organization identifiers and source identifiers.

The server generates a prompt sentence corresponding to the normalized data. The server uses a prompt generation module that constructs a textual instruction targeted to a generative AI model. The server selects a prompt template based on the analysis purpose, such as competitive comparison or feature extraction, and fills variable fields with descriptors of the organizations and context. For example, the server generates a prompt sentence such as: “You are a market analyst. Please summarize the following customer reviews about our product. Focus on the main strengths, weaknesses, repeated complaints, and common praise points.”or

“You are a business analyst. Please summarize the following text, focusing on the main strengths, weaknesses, and recurring themes.”

The server may also generate a prompt sentence for the second organization, such as: “You are a market analyst. Please summarize the following customer reviews about a competitor's product. Focus on the main strengths, weaknesses, repeated complaints, and common praise points.”

The server combines the prompt sentence and the normalized data into an input structure for the generative AI model. When the generative AI model is accessed via an external service, the server converts the combination into a request message formatted according to an application programming interface. When the generative AI model is locally deployed, the server encodes the prompt sentence and the normalized data into token sequences using a tokenizer associated with the model.

The server interacts with a generative AI model that is implemented as a multi-layer neural network. In one embodiment, the generative AI model is a transformer-based architecture comprising an embedding layer, multiple self-attention layers, feed-forward sublayers, and an output projection layer. The server relies on a model that has been pre-trained on large corpora of natural language text using an unsupervised or self-supervised learning objective, such as next-token prediction or masked token reconstruction. During pre-training, a training module outside the server minimizes a loss function such as cross-entropy between predicted tokens and ground-truth tokens, and updates model weights using gradient-based optimization, such as stochastic gradient descent with adaptive learning rate. The model learns internal parameters including attention weights, feed-forward weights, and layer normalization parameters. Fine-tuning may be applied to adjust the model on domain-specific data.

The server inputs the prompt sentence and normalized data to the generative AI model and obtains summary information. The server provides the tokenized input along with configuration parameters such as maximum output length, temperature, and probability thresholds. The model processes the input sequence through multiple attention and feed-forward layers, computing intermediate feature representations at each layer. The output layer produces probability distributions over a vocabulary, and decoding logic selects tokens according to configured decoding strategies. The server decodes the tokens back into text, thereby obtaining summary information for each organization. This process exploits the learned internal attention patterns of the model to highlight semantically central content, which differs from simple keyword-based extraction rules and improves summarization quality and robustness across domains.

The server further transforms the summary information into structured feature information. The server uses a natural language processing module that includes tokenization, morphological analysis, and frequency calculation. The server segments the summary text into tokens by using a language-appropriate tokenizer. The server performs morphological analysis, including part-of-speech tagging, to identify nouns, noun phrases, and other content-bearing terms. For example, the server identifies terms related to performance, price, reliability, usability, and support. The server computes term frequencies within each summary, and optionally normalizes these frequencies, for example by document length. The server then constructs structured data objects that map each term to one or more feature values, such as raw frequency, normalized frequency, and part-of-speech tags.

The server aggregates tokens into higher-level features. The server groups semantically related terms using pre-defined lexicons, vector similarity measures, or clustering over term embeddings. The server may compute vector representations of tokens using an embedding model and cluster these vectors to derive topic-like groupings. In this manner, the server generates feature information representing both specific terms and broader topics. The structured data thus includes, for each organization, a set of keywords and topics with associated numerical attributes.

The server computes comparison information between the feature information for different organizations. The server aligns feature spaces by taking the union of terms across organizations and creating a comparison structure for each shared or distinct term. The server computes an occurrence degree for each term per organization, such as frequency or weighted importance. The server then calculates difference indices, such as differences in frequencies, ratios of frequencies, or statistical distance measures. The server may compute significance scores that reflect how strongly a term characterizes one organization relative to another, using measures such as TF-IDF-like weighting or log-odds ratios. The server stores these results in comparison data structures that associate each feature with occurrence degrees and difference indices across organizations.

The server generates image information to visualize the comparison information. The server uses a visualization module that interfaces with a plotting library. The server selects a graph type such as a bar graph or a line graph based on the nature of the feature data. For a bar graph, the server maps terms or topics to positions on a horizontal axis and maps occurrence degrees to bar heights. The server generates grouped bars to show different organizations side-by-side for each feature. For a line graph, the server may map ordered features or temporal changes to the horizontal axis and occurrence degrees to the vertical axis. The server configures axis labels, legends, and scaling, and renders the graph into an image buffer. The image information is encoded in a standard image format suitable for transmission and display, such as PNG.

The server generates display data comprising the summary information, the comparison information, and the image information. The server constructs a response payload including textual summary sections, structured tables of comparison metrics, and binary image data or references to stored image files. The server transmits the display data via the network interface to a user terminal. The server may also apply compression or caching strategies to reduce communication load and latency.

The terminal receives the display data and renders it to the user. The terminal parses the received information, displays textual summaries in separate sections for each organization, displays tabular comparison metrics such as keyword frequencies and difference indices, and displays generated graphs. The user observes these outputs and can interact with the terminal, for example by selecting subsets of features, adjusting filters, or requesting additional analyses. The terminal sends such interaction requests back to the server, which may trigger additional prompt generation and refined analyses.

In a further embodiment, the server generates additional prompt sentences based on the summary information. The server uses the initial summaries as input context and formulates refined prompts that instruct the generative AI model to output more structured information. For example, the server generates a prompt sentence such as:

“Please extract and list the top 10 key points from the following summary, with each point presented as a short bullet.”

The server inputs the additional prompt sentence and the summary information to the generative AI model. The model then produces a refined summary structured as a list of key points. The server parses this output and converts each key point into feature records. This process leverages the generative AI model's capability to restructure text according to explicit instructions, which is difficult to reproduce with conventional rule-based post-processing and leads to more machine-amenable summaries.

In another embodiment, the server computes emphasized elements by comparing occurrence degrees across organizations and generates prompt sentences for interpretive explanations. For example, the server identifies terms with high positive differences for the first organization as strengths of the first organization, and terms with high positive differences for the second organization as strengths of the second organization. The server composes a prompt sentence such as:

“Based on the following list of strengths and weaknesses for two organizations, explain in natural language how the first organization differs from the second organization, and suggest improvement measures for the weaker aspects.”

The server inputs the classification result and the prompt sentence to the generative AI model and receives explanatory information. The server includes this explanatory information in the display data. This combined deterministic-computational and generative interpretation pipeline reduces the need for manual expert commentary and ensures that explanations are aligned with quantified differences, which improves the consistency and reliability of outputs.

The server architecture improves computer technology in several ways. By using normalized data structures and structured feature representations, the server reduces redundant computations across modules and minimizes parsing overhead. By delegating content condensation to a generative AI model with learned attention structures, the server reduces the size of data passed to downstream natural language processing and comparison modules, thereby lowering memory consumption and processing time for large corpora. The explicit separation of prompt generation, model interaction, and feature structuring allows the server to adjust summarization behavior without retraining models, improving adaptability while maintaining computational efficiency.

The server achieves improved accuracy compared to conventional keyword extraction by using summaries produced by a deep neural transformer model as input to deterministic NLP and statistical processing. Because the generative AI model filters out peripheral content and emphasizes central themes, the subsequent frequency calculations are less affected by noise and irrelevant phrases. This yields more stable and informative difference indices across organizations. The use of trained attention mechanisms and context-sensitive embeddings allows the system to handle synonyms, paraphrases, and domain-specific terms that static lexicon-based systems cannot robustly manage.

The training of the generative AI model contributes to technical improvements as well. The model is trained on large-scale corpora with regularization techniques and optimization schemes that minimize generalization error under diverse linguistic conditions. Training uses batch processing, gradient computation, and parameter updates over billions of tokens, with error functions determined by prediction mismatches. This process produces weight configurations that encode complex linguistic and semantic structures, enabling efficient summarization and transformation of new inputs with a single forward pass per inference. As a result, the server can process large volumes of text with fewer hand-crafted rules, reducing maintenance overhead and improving responsiveness.

The server also applies non-conventional processing flows that are not mere automation of human reading and comparison tasks. For instance, the server automatically segments texts based on token limits of the generative AI model, schedules batched requests to maximize throughput on model inference hardware, merges partial summaries in a hierarchical manner, and generates feature-level metrics optimized for machine comparison rather than human reading. The server implements rules for feature alignment and difference index calculation that consider distributional statistics across multiple documents, which a human user would not feasibly compute manually in real time. These algorithmic flows lead directly to reduced latency, improved throughput, and lower error rates in feature extraction and comparison. In alternative embodiments, the server may deploy the generative AI model locally on specialized acceleration hardware such as graphics processing units or tensor processing units. In such cases, the server manages memory allocation for model weights, activation buffers, and intermediate states. The server schedules inference tasks to share the acceleration hardware among concurrent requests, optimizing batch sizes to maintain utilization while meeting latency constraints. These capabilities further improve technical performance by maximizing hardware resource use and minimizing contention.

In another variation, the server may employ different neural architectures, such as encoder-only models for summarization or encoder-decoder models for more complex generation tasks. The server may also incorporate additional feature extraction modules, such as topic modeling algorithms, clustering algorithms, or sentiment analysis modules, to expand the feature information. The server can adjust the prompt sentences and feature processing parameters according to the selected architecture.

The described embodiments thus provide a concrete technical framework in which the server, the generative AI model, and the natural language processing and visualization modules are integrated through specific data structures, prompt sentences, and numerical computations. The integration results in improved processing speed, reduced communication overhead through condensed summaries, enhanced accuracy of feature extraction and comparison, and automated generation of visual artifacts suitable for direct display on user terminals. These improvements are achieved through specific configurations and algorithmic flows within the computer system, rather than mere automation of human reasoning.

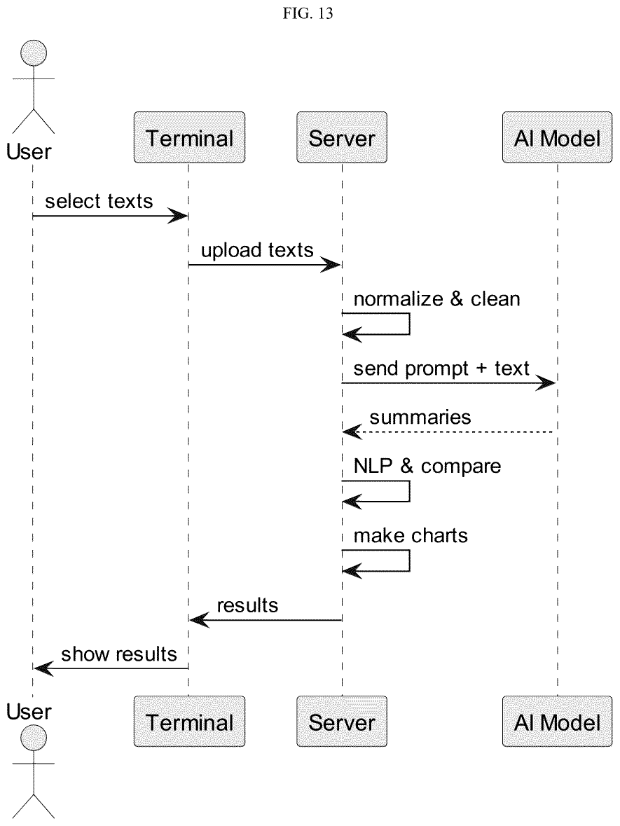

The following describes the processing flow using FIG. 13.

### Step 1

The user prepares organization-related text data.

The user selects documents such as customer reviews, reports, or descriptions corresponding to a first organization and a second organization, and stores them as text files on a terminal.

Input: Raw text files for the first organization and the second organization.

Output: Selected text files ready for upload on the terminal.

### Step 2

The terminal transmits the selected text files to the server.

The terminal executes a browser or application, attaches the text files to a request, and sends the request via a communication network to a predefined endpoint of the server.

Input: Selected text files and user request metadata.

Output: Network request containing the text files and metadata delivered to the server.

### Step 3

The server receives and stores the transmitted text data.

The server reads the request, extracts the attached text files, and writes their contents into main memory and, optionally, into a storage device with identifiers for the first organization and the second organization.

Input: Network request with attached text files.

Output: In-memory text buffers and stored text records labeled by organization.

### Step 4

The server normalizes the character information.

The server converts the text encoding to a unified encoding, removes invalid characters, standardizes whitespace and punctuation, and applies language-specific normalization such as case folding and width normalization. The server uses string processing routines to transform the raw text into a clean, consistent representation.

Input: Raw text buffers for the first and second organizations.

Output: Normalized text data objects for the first and second organizations.

### Step 5

The server removes noise from the normalized text.

The server applies rule-based filters to delete HTML tags, markup, boilerplate segments, and non-content elements. The server may search for known patterns such as script tags or navigation menus and discard them. This data processing reduces irrelevant segments that would degrade subsequent analysis.

Input: Normalized text data objects.

Output: Cleaned text data objects with noise removed for the first and second organizations.

### Step 6

The server segments the cleaned text into manageable portions.

The server counts tokens or characters and divides long texts into segments that satisfy size constraints of a generative AI model. The server creates ordered lists of segments, each associated with an organization identifier.

Input: Cleaned text data objects for each organization.

Output: Segment lists containing text segments and corresponding organization identifiers.

### Step 7

The server generates a base prompt sentence for summarization.

The server selects a prompt template according to an analysis mode and inserts context parameters such as “first organization” or “second organization.” For example, the server constructs a prompt sentence:

“You are a market analyst. Please summarize the following customer reviews about our product. Focus on the main strengths, weaknesses, repeated complaints, and common praise points.”

Input: Analysis mode and organization context information.

Output: Base prompt sentences for the first organization and the second organization.

### Step 8

The server combines each text segment with the corresponding prompt sentence.

The server concatenates the base prompt sentence with a segment or encodes them into a joint input structure for a generative AI model. The server ensures that the combined length remains within model limits.

Input: Base prompt sentences and segment lists for each organization.

Output: Prompted input units, each containing a prompt sentence and a corresponding text segment.

### Step 9

The server sends the prompted input units to a generative AI model.

The server tokenizes each prompted input using a tokenizer, converts tokens into numerical identifiers, and transmits them to the generative AI model via an interface. The server specifies parameters such as maximum output tokens and decoding options.

Input: Prompted input units containing prompt sentences and segments.

Output: Model input batches consisting of token sequences and configuration parameters.

### Step 10

The server receives summary information from the generative AI model.

The server obtains output token sequences produced by the model, decodes them back into text, and associates each summary with the corresponding segment and organization. The generative AI model internally applies multi-layer attention and feed-forward operations to generate context-aware summaries.

Input: Model input batches with tokens and parameters.

Output: Segment-level summary texts for the first and second organizations.

### Step 11

The server integrates segment-level summaries into organization-level summaries.

The server concatenates or hierarchically merges the segment-level summaries for each organization. The server may apply another summarization step using a prompt sentence such as “Please summarize the following multiple summaries into one unified summary.” and sends the merged text to the generative AI model to obtain a final, consolidated summary per organization.

Input: Segment-level summaries grouped by organization.

Output: Integrated summary information for the first organization and the second organization.

### Step 12

The server generates an additional prompt sentence for refined summaries.

The server constructs a refined prompt sentence such as:

“Please extract and list the top 10 key points from the following summary, with each point presented as a short bullet.”

The server associates this refined prompt with each integrated summary to prepare a second interaction with the generative AI model.

Input: Integrated summaries and refinement requirements.

Output: Refined prompt sentences paired with integrated summaries.

### Step 13

The server requests refined summaries from the generative AI model.

The server sends the refined prompt sentences and integrated summaries to the generative AI model, receives output texts formatted as lists of key points, and decodes them into plain text.

Input: Refined prompt sentences and integrated summaries.

Output: Refined summaries in list format for the first and second organizations.

### Step 14

The server tokenizes the refined summaries.

The server applies a tokenizer to split each refined summary into tokens, such as words or morphemes, using a natural language processing library. The server records token boundaries and token strings.

Input: Refined summaries for each organization.

Output: Token sequences representing refined summaries for the first and second organizations.

### Step 15

The server performs morphological analysis on the token sequences.

The server assigns part-of-speech tags and other morphological attributes to each token using a morphological analysis component. The server identifies content-bearing tokens such as nouns, noun phrases, and adjectives that are suitable for feature extraction.

Input: Token sequences for each organization.

Output: Annotated token sequences with part-of-speech and morphological attributes.

### Step 16

The server calculates term frequencies from the annotated tokens.

The server counts occurrences of each token that satisfies selection criteria, such as being a noun or keyword candidate. The server normalizes frequencies by text length or document count as needed.

Input: Annotated token sequences for each organization.

Output: Frequency tables mapping tokens to occurrence degrees for the first and second organizations.

### Step 17

The server constructs structured feature information per organization.

The server converts frequency tables and morphological attributes into structured records. Each record includes a term, its frequency, normalized frequency, and optional category. The server stores these records as feature sets for each organization.

Input: Frequency tables and annotated tokens.

Output: Structured feature information for the first organization and the second organization.

### Step 18

The server aligns feature spaces between organizations.

The server builds a unified feature index by taking the union of terms from both organizations. The server maps frequencies from each organization onto this common index, resulting in a matrix or aligned list where each term has per-organization metrics.

Input: Structured feature information for both organizations.

Output: Aligned feature structure containing per-term metrics for each organization.

### Step 19

The server computes comparison information including occurrence degrees and difference indices.

The server calculates, for each term, measures such as frequency differences, frequency ratios, or other statistical indices between the organizations. The server may compute additional significance measures that highlight terms that strongly distinguish one organization from the other.

Input: Aligned feature structure with per-organization frequencies.

Output: Comparison information containing occurrence degrees and difference indices for each term.

### Step 20

The server classifies emphasized elements for each organization.

The server compares the occurrence degree of each term between organizations and marks terms with higher occurrence for a specific organization as emphasized elements for that organization. The server groups emphasized elements into categories, such as strengths and weaknesses, based on predefined thresholds or rules.

Input: Comparison information with occurrence degrees and difference indices.

Output: Classification results indicating emphasized elements for each organization.

### Step 21

The server generates a prompt sentence for explanatory information.

The server creates a prompt sentence that describes the classification results and requests interpretive explanation and improvement suggestions. For example, the server generates: “Based on the following list of strengths and weaknesses for two organizations, explain how the first organization differs from the second organization, and suggest improvement measures for the weaker aspects.”

Input: Classification results and explanation requirements.

Output: Explanatory prompt sentence combined with structured classification data.

### Step 22

The server obtains explanatory information from the generative AI model.

The server sends the explanatory prompt sentence and the classification data to the generative AI model, receives an explanation text, and decodes it. The explanation text describes differences and potential improvements, based on the quantified features.

Input: Explanatory prompt sentence and classification data.

Output: Explanatory information in natural language.

### Step 23

The server generates visual comparison data.

The server selects a set of key terms or topics from the comparison information and prepares numerical arrays for graph generation, including occurrence degrees for each organization. The server uses a plotting library to create bar graphs or line graphs that visually display differences in occurrence degrees.

Input: Comparison information and selected features.

Output: Image data representing graphs that visualize feature differences.

### Step 24

The server composes display data for the terminal.

The server combines the integrated summaries, refined summaries, comparison information, explanatory information, and image data into a response structure. The server includes text segments, structured tables, and encoded images or references suitable for rendering on the terminal.

Input: Summaries, feature information, comparison information, explanatory information, and graph images.

Output: Aggregated display data package ready for transmission.

### Step 25

The server transmits the display data to the terminal.

The server sends the display data through the communication network to the terminal as a response to the user request. The server may apply compression or caching policies to reduce latency and bandwidth usage.

Input: Aggregated display data package.

Output: Network response containing the display data delivered to the terminal.

### Step 26

The terminal renders the received display data to the user.

The terminal parses the received data, displays the organization-level summaries, shows tables of comparison metrics, renders the graphs, and presents explanatory text. The terminal arranges these elements in a user interface that allows the user to review and compare the organizations.

Input: Display data from the server.

Output: Visual and textual presentation of analysis results on the terminal screen.

### Step 27

The user reviews the presented analysis results.

The user reads the summaries, inspects the graphs and comparison metrics, and interprets the explanatory information. The user may decide to adjust analysis parameters or submit additional requests based on the insights obtained.

Input: Visual and textual presentation on the terminal.

Output: Human understanding and potential new analysis requests initiated by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional competitive analysis and content creation systems generally treat text analytics, prompt construction for generative AI models, and user interaction as loosely coupled and manually orchestrated components. In such systems, a human operator typically has to (i) search and collect competitor information from various network resources, (ii) clean and normalize the data, (iii) manually craft prompt sentences for a generative AI model, (iv) interpret the generated summaries, and (v) separately adjust proposals or advertisements based on the perceived emotional state of a user or customer. This fragmented workflow leads to several technical problems in computer technology.

First, existing systems incur high processing latency and resource consumption because they repeatedly perform end-to-end data collection and model invocation without reusing previously generated summaries, comparisons, or prompt configurations. The computing apparatus lacks a mechanism to treat historical AI inputs and outputs as structured history information that can be leveraged to optimize subsequent processing. As a result, the processor performs redundant network communication, parsing, and model inference for similar or recurring competitive situations, which is inefficient in terms of CPU, memory, and network bandwidth.

Second, conventional architectures provide limited integration between emotion recognition pipelines and text generation pipelines. Emotion recognition modules typically run in isolation, and their outputs are not systematically injected into the prompt sentences used by a generative AI model. Consequently, the computing apparatus does not automatically adapt the generated proposal information or advertisement information to the real-time emotional state of the user. This causes a mismatch between the user's affective context and the generated content, and prevents the system from computationally optimizing engagement and effectiveness.

Third, current systems do not provide a technical mechanism by which the processor can autonomously refine prompt sentence templates based on accumulated history information, including previous prompt sentences, summary information, viewpoint information, emotional state data, and result information. Without such feedback-driven refinement, the generative AI model is repeatedly invoked with sub-optimal prompts, which degrades output quality and wastes computational resources. There is no closed-loop control in the computing system that systematically tunes the prompt configuration to improve model behavior over time.

Fourth, many existing competitive analysis tools fail to integrate cross-source information—namely, external competitive organization information from network resources and internal activity information from information storage resources—into a unified comparison and advantage viewpoint generation pipeline. The absence of an automated pipeline that (i) constructs prompt sentences from both external and internal data, (ii) invokes a generative AI model to generate summary information, and (iii) synthesizes viewpoint information regarding organizational advantage, forces users to perform manual correlation and interpretation tasks outside the system. This introduces human bottlenecks and prevents the computing system from providing timely, consistent outputs.

Accordingly, there is a need for an improved computer-implemented system and method that: (1) automatically collects and preprocesses organization-related information from heterogeneous data sources; (2) constructs and refines prompt sentences for a generative AI model in a history-aware manner; (3) generates summary information, viewpoint information regarding organizational advantage, and differentiated expression and visual information; (4) integrates emotion recognition data into prompt construction to produce emotion-adaptive proposal and advertisement information; and (5) reuses and partially updates existing AI outputs to reduce processing time and computational load for new user requests. The technical problem to be solved is to provide a processor-implemented architecture that addresses these deficiencies and thereby improves the operation of the computer system itself in terms of latency, resource utilization, content relevance, and adaptability.

The specific processing by the specific processing unit 290 of the data processing device 12 in Application Example 2 is realized by the following means.

The present invention provides a server comprising a processor configured to automatically collect organization-related information from at least one network resource and at least one information storage resource, convert the collected information into character-based information and perform preprocessing that removes format information and unnecessary information from the character-based information, construct a prompt sentence based on the preprocessed character-based information and internal activity information of an organization, the prompt sentence being configured to instruct a generative AI model to perform analysis and summarization of the information, input the prompt sentence and the character-based information into the generative AI model and cause the generative AI model to generate summary information regarding a competitive organization, compare the summary information with the internal activity information of the organization and generate viewpoint information regarding an advantage of the organization by extracting common points and differences, construct differentiated expression information and visual information for a sales activity or a promotion activity based on the viewpoint information, acquire an emotional state of a user by using an emotion recognition technology, input the emotional state into the generative AI model together with the prompt sentence and cause the generative AI model to generate proposal information or advertisement information adjusted according to the emotional state, provide result information including the summary information, the viewpoint information, and the proposal information or the advertisement information to an output information processing terminal, store the prompt sentence, the summary information, the viewpoint information, the emotional state, and the result information as history information, update a configuration of the prompt sentence based on the history information so as to sequentially improve information generation performance of the generative AI model, and identify, based on the history information, organization information or competitive organization information similar to newly processed information and shorten processing time for a new user request by reusing or partially updating existing summary information or viewpoint information. This enables the computer system to execute a closed-loop, history-aware pipeline that reduces redundant processing, improves prompt effectiveness and generative AI output quality, adapts generated proposals and advertisements to real-time user emotions at the system level, and delivers competitive analysis and differentiated content with reduced latency and improved utilization of computational and network resources.

The term “processor” refers to a hardware execution unit, such as a central processing unit or graphics processing unit, that is configured to execute instructions to perform the collection, preprocessing, analysis, generation, comparison, storage, and output of information as described in the present specification.

The term “network resource” refers to any information source accessible through a communication network, including but not limited to web sites, web application programming interfaces, news feeds, and online data repositories that provide organization-related information.

The term “information storage resource” refers to any local or remote data storage component, such as a database, file system, or data warehouse, that stores internal activity information or previously collected external information regarding an organization.

The term “organization-related information” refers to data describing activities, products, services, strategies, or public communications of any entity, including the entity operating the system and one or more competitive entities.

The term “character-based information” refers to information that has been converted into a textual representation, such as a sequence of characters or tokens, suitable for further processing by natural language processing techniques and generative AI models.

The term “format information” refers to structural or presentation elements of data, such as markup tags, style attributes, layout information, or control codes, that do not constitute the substantive semantic content to be analyzed.

The term “unnecessary information” refers to data elements that are not required for the intended analysis or generation task, including but not limited to navigational text, advertising noise, duplicated sections, boilerplate disclaimers, or tracking parameters.

The term “preprocessing” refers to one or more operations applied to raw data to prepare it for analysis, such operations including parsing, text extraction, normalization, noise removal, tokenization, and other transformations that produce cleaned character-based information.

The term “internal activity information” refers to data stored within an information storage resource that describes the operations, campaigns, products, strategies, or historical decisions of the organization using the system.

The term “prompt sentence” refers to a sequence of character-based information that encodes an instruction or query to a generative AI model, including context and constraints, and that is used to cause the generative AI model to perform analysis, summarization, comparison, or content generation.

The term “generative AI model” refers to a machine learning model capable of generating new character-based information, such as natural language text, based on input prompts and context, and including models implementing large-scale neural network architectures.

The term “summary information” refers to character-based information produced by the generative AI model that expresses, in a condensed form, the salient points of one or more source data items regarding a competitive organization.

The term “competitive organization” refers to any entity that offers products or services that are considered alternatives or substitutes to the products or services of the organization operating the system.

The term “viewpoint information” refers to character-based information generated by the processor that expresses an analysis or opinion regarding the relative advantage or disadvantage of the organization, derived from a comparison of summary information and internal activity information.

The term “advantage of the organization” refers to any identified strength, benefit, or favorable characteristic of the organization's products, services, or activities, as determined by analyzing differences and commonalities relative to competitive organizations.

The term “differentiated expression information” refers to character-based information that is generated to linguistically emphasize distinctions between the organization and competitive organizations for use in sales activities or promotion activities.

The term “visual information” refers to information describing visual elements, including but not limited to charts, diagrams, layouts, and other graphic structures, that can be rendered or used to communicate comparative or promotional content.

The term “sales activity” refers to actions, campaigns, or communications that are intended to promote, propose, or sell products or services of the organization to potential or existing customers.

The term “promotion activity” refers to actions, campaigns, or communications that are intended to increase awareness, interest, or preference for the organization's products, services, or brand.

The term “emotion recognition technology” refers to any hardware, software, or combination thereof configured to detect or estimate an emotional state of a user based on one or more signals, such as facial images, voice characteristics, physiological signals, or interaction patterns.

The term “emotional state” refers to a representation of a user's affective condition, such as joy, interest, frustration, or neutrality, expressed as labels, scores, or other machine-processable data derived from emotion recognition technology.

The term “proposal information” refers to character-based information generated for suggesting or recommending products, services, or actions to a user or customer, including but not limited to sales proposals and offer descriptions.

The term “advertisement information” refers to character-based information generated for use in advertising contexts, including but not limited to headlines, body copy, slogans, and calls to action.

The term “result information” refers to an aggregation of one or more types of information generated by the processor, including summary information, viewpoint information, proposal information, advertisement information, or any combination thereof, prepared for delivery to an output information processing terminal.

The term “output information processing terminal” refers to any computing device configured to receive result information from the server and to present the result information to a user, including but not limited to a workstation, mobile device, or wearable device.

The term “history information” refers to stored data comprising at least one of prompt sentences, summary information, viewpoint information, emotional states, result information, and metadata associated with such information, accumulated over time for reuse and analysis.

The term “configuration of the prompt sentence” refers to structural and content attributes of a prompt sentence, including wording, ordering of elements, inclusion of constraints, and selection of contextual data used to instruct the generative AI model.

The term “information generation performance” refers to one or more qualitative or quantitative characteristics of outputs from the generative AI model, including relevance, coherence, specificity, response time, and alignment with intended tasks, as achieved when using particular prompt sentences and contexts.

The term “organization information” refers to data describing an organization, including but not limited to internal activity information, product or service descriptions, and strategic or operational attributes.

The term “similar to newly processed information” refers to having a degree of correspondence, as determined by one or more similarity metrics, between stored history information and current input information, such that reuse or partial update of existing outputs is feasible.

The term “processing time for a new user request” refers to an elapsed time interval between receipt of a user's request by the system and availability of corresponding result information for delivery to an output information processing terminal.

In one embodiment, a server, a terminal, and a user cooperate to implement the claimed system. The server includes at least one processor, a main memory, a non-volatile storage device, and one or more network interfaces. The server is connected via one or more communication networks to one or more terminals and to external network resources. The terminal includes at least one processor, a memory, a display, an input device, a camera, and a microphone. The server executes software components including a web crawling module, a preprocessing module, a history management module, a prompt construction module, a generative AI interface module, a comparison and advantage analysis module, an emotion integration module, and an output assembly module.

The server uses a general-purpose operating system, such as a server-class operating system, and executes application software implemented, for example, in an interpreted or compiled programming language. The server stores data in data structures, such as relational tables in a relational database management system or documents in a document-oriented database. Each record of organization-related information includes at least a source identifier, a timestamp, a textual content field, and one or more labels identifying the organization and campaign. The server acquires organization-related information from network resources by executing a web crawling module. The server sends HTTP or HTTPS requests to multiple URLs and receives HTML documents, JSON documents, or other structured data. The server parses the received data using a markup parser to extract text segments relevant to organization activities. The server stores the raw responses in a storage device before preprocessing. The server executes a preprocessing module that converts the collected organization-related information into character-based information. The server removes markup tags, style elements, scripting code, and tracking parameters. The server applies tokenization, sentence segmentation, stop-word removal, and lemmatization using a natural language processing library. The server stores the preprocessed text in a normalized format, for example, as sequences of tokens with associated document identifiers. The server thereby creates cleaned, machine-processable text that can be efficiently supplied to downstream modules.

The server maintains internal activity information of an organization in an information storage resource. The server stores internal activity information, including summaries of campaigns, product specifications, pricing tables, and strategic narratives, in a database that uses keys identifying products, time ranges, and markets. The server indexes both organization-related information and internal activity information using lexical and vector-based indices to enable rapid similarity searches and retrieval for subsequent processing.

The server constructs a prompt sentence for a generative AI model by executing a prompt construction module. The server selects relevant preprocessed texts and internal activity information, concatenates them with structural delimiters, and generates an instruction sentence configured to cause a generative AI model to perform analysis and summarization. The server may generate different kinds of prompt sentences for different tasks, such as summarization, comparison, and content creation. Examples of prompt sentences include: “Summarize the following competitor advertising campaign. Identify the target audience, the main message, the channels used, and the unique selling points. Output in 5 bullet points.” “Compare our internal campaign data (Section A) with the competitor campaign summary (Section B). List similarities and differences, and highlight our potential advantages.” “Using the following comparison, generate a clear and persuasive explanation of our competitive advantages suitable for a client presentation.”

The server interfaces with a generative AI model via a generative AI interface module. The generative AI model is, in one embodiment, a transformer-based neural network with multiple layers of self-attention and feed-forward blocks, trained on large-scale text corpora using an auto-regressive objective. The server represents a prompt sentence and context as a sequence of tokens and transmits the tokens to the generative AI model. The generative AI model computes hidden representations at each layer using a self-attention mechanism that calculates attention scores between tokens based on learned weight matrices. The generative AI model then computes output token probabilities using a final linear layer and a softmax function. The generative AI model has been trained using gradient-based optimization, where a loss function such as cross-entropy between predicted tokens and target tokens is minimized, and weight parameters are updated according to back-propagation.

The server, when the generative AI model is hosted locally, stores model parameters in optimized tensor formats and uses a parallel computation library to execute matrix multiplications on a graphics processing unit or other specialized accelerator. The server loads batches of tokens and uses fixed-point or mixed-precision arithmetic to accelerate inference processing and reduce energy consumption. By using vectorized operations and caching of attention key-value pairs, the server reduces per-token latency and achieves faster response times than a naïve implementation.

The server uses a comparison and advantage analysis module to compare summary information generated by the generative AI model with internal activity information. The server structures the summary information and internal activity information as feature vectors representing, for example, marketing channels, price positions, feature sets, and target segments. The server computes differences and commonalities using an algorithm that compares these feature vectors and identifies dimensions where the organization has numerical or categorical advantages. The server then constructs viewpoint information, which is character-based information describing the advantage of the organization, either directly by algorithmic rules or by including the structured comparison as context in a further prompt sentence to the generative AI model.

The server constructs differentiated expression information and visual information by using the generative AI model with specialized prompt sentences. The server selects viewpoint information and supplies it as context. The server requests the generative AI model to produce text segments that emphasize distinctions between the organization and competitive organizations. The server also requests verbal descriptions of visual representations, such as bar charts or comparison tables, that can be rendered by a separate visualization module. Example prompt sentences for this include:

“Generate three alternative taglines and short body copy that emphasize our 20% weight reduction and 30% longer battery life compared to Competitor A.”

“Describe two visual concepts that highlight our advantages versus competitors, such as a comparison chart or infographic.”

The terminal captures a user's emotional state by operating a camera and microphone under control of an emotion acquisition application. The terminal sends captured images and audio signals to an emotion recognition engine. The emotion recognition engine applies feature extraction, such as facial landmark detection and voice pitch analysis, followed by a classifier such as a convolutional or recurrent neural network, to predict an emotional state distribution. The terminal transmits the resulting emotional state to the server in a standardized format, including time stamps and confidence scores.

The server integrates the emotional state into prompt construction by executing an emotion integration module. The server conditions prompt sentences on the emotional state so that the generative AI model receives explicit information about whether the user is, for example, joyful, neutral, or dissatisfied. The server generates prompt sentences such as:

“Customer emotion: joy and interest. Using the following competitive advantages, generate an enthusiastic but concise advertisement suitable for a social media platform.”

“Customer emotion: dissatisfaction about price. Rewrite the proposal to focus on long-term cost savings and risk reduction, and use empathetic wording.”

The server then supplies these prompt sentences and associated context to the generative AI model. The generative AI model produces proposal information or advertisement information that is explicitly conditioned on the emotional state. This processing goes beyond mere automation of human drafting tasks because the emotion information is represented as structured, time-synchronized data that is algorithmically combined with analysis outputs, enabling content generation paths that cannot be easily replicated by manual processes. The server maintains history information in a history management module. The server records, for each processing session, the prompt sentence, the summary information, the viewpoint information, the emotional state, and the result information, together with metadata such as time, user identifier, and performance metrics. The server organizes this history information in a database using indices on organization identifiers and vector embeddings of textual content. The server retrieves similar past sessions by computing similarity between the embedding of a new request and embeddings of stored history items.

The server refines the configuration of prompt sentences based on history information. The server evaluates the quality of generative AI outputs using explicit user feedback, such as ratings or acceptance rates, and implicit indicators, such as editing distance between generated text and final text used by the user. The server updates a parameterized template describing the structure of prompt sentences. For example, the server may add constraints on output length, adjust the level of technical detail, or reorder context sections. The server implements a rule-based or machine-learned optimization algorithm that selects template variants with better observed performance. This systematic refinement directly changes token sequences sent to the generative AI model, leading to improved output relevance and reduced post-editing by users.

The server identifies opportunities to reuse or partially update existing summary information or viewpoint information. When a new user request is received, the server computes a similarity score between the new request and previous items in history information. If the similarity exceeds a threshold, the server retrieves the corresponding summary information or viewpoint information and either returns it as-is or submits a shorter prompt sentence that asks the generative AI model to update only changed aspects. In this way, the server avoids redundant full analysis of highly similar organization-related information, reducing the number of tokens that must be processed and consequently reducing computational load and network communication with external AI services.

The server assembles result information by combining summary information, viewpoint information, and proposal or advertisement information in a structured representation. The server may produce a machine-readable format for consumption by other software modules and a human-readable format for display on the terminal. The server includes visual information, such as chart specifications, which a graphical rendering engine on the terminal may interpret to generate visual representations on the display. The server's integration of analysis, comparison, emotion conditioning, and reuse mechanisms yields result information with consistent structure and high information density.

The terminal presents result information to the user via a graphical user interface. The terminal allows the user to view summaries, comparisons, and tailored proposals, and to provide feedback such as acceptance, rejection, and modification commands. The terminal transmits feedback data to the server, where it is incorporated into history information and used to further refine prompt sentence templates and reuse strategies. The user thus interacts with a dynamically improving system that continually adapts its internal processing configuration.

The described architecture improves computer technology in several specific ways. The server reduces average processing time by using similarity-based reuse of history information, thereby avoiding repeated full-scale generative analysis for similar inputs. The server improves computational efficiency by controlling prompt length and context selection, which reduces the number of tokens processed by the generative AI model and decreases both inference latency and network traffic to external AI services. The server enhances data management by storing structured history information and by using vector indices that enable efficient retrieval of semantically similar past sessions. The server improves output accuracy and relevance by operating a closed feedback loop that adjusts prompt configuration based on empirical performance, a mechanism not available in conventional manual workflows. The server's integration of emotion recognition information into prompt construction introduces a non-conventional technical interaction between sensing hardware on the terminal and inference processing on the server. Emotion signals acquired from a camera and microphone are converted into numerical descriptors and condition the content path taken by the generative AI model. This allows the overall system to adapt its internal inference strategy and optimize generated content in a way that cannot be achieved by straightforward human drafting or by simple rule-based templates.

In some embodiments, the server executes alternative implementations of modules. The generative AI model may be hosted on-premises on a specialized inference server or accessed as a remote service, with the generative AI interface module adapting token batching and concurrency parameters to the available hardware. The emotion recognition technology may be implemented fully on the terminal for privacy-preserving processing, with only derived emotional state scores transmitted to the server, or may be implemented as a server-side service receiving anonymized feature vectors. The history management module may use different indexing strategies, such as tree-based indices or graph-based similarity search, to scale to large volumes of history information.

The system thereby provides concrete improvements in the way a computer system collects, transforms, stores, and uses data in interaction with a generative AI model. By defining specific data structures for history information, by implementing prompt sentence refinement algorithms, by reusing partial outputs, and by conditioning content generation on sensed emotional state, the server performs operations that are specifically tailored to the capabilities and limitations of modern computing hardware and networked AI services, and that produce technical effects such as reduced latency, decreased computational load, and improved alignment between machine-generated content and user context.

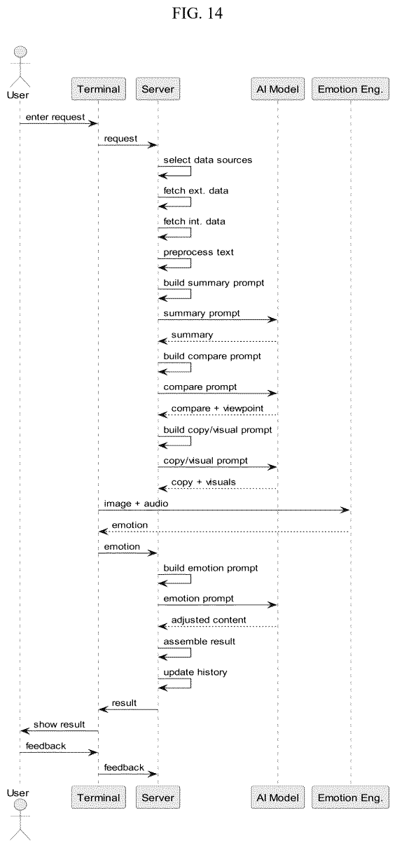

The following describes the processing flow using FIG. 14.

### Step 1

User initiates a request.

User inputs a natural language request into the terminal, for example, “Analyze Competitor A's latest campaign and compare it with our current campaign.”

Input: free-form text from the user.

Terminal packages the text with user ID and context into a request message.

Output: a structured request message transmitted to the server via a network connection.

### Step 2

Server interprets the request and selects data sources.

Server receives the structured request message and parses the text to detect organization names, product names, time ranges, and requested analysis types using a natural language parsing module.

Input: structured request message from the terminal.

Server generates a list of target network resources (e.g., competitor sites, news feeds) and internal databases to be queried based on the parsed entities.

Output: a data source list including external URLs and internal database query parameters.

### Step 3

Server acquires external organization-related information.

Server uses the data source list to invoke a web crawling module. The server sends HTTP/HTTPS requests to each URL and downloads HTML pages, JSON responses, or other documents describing competitor activities.

Input: list of target URLs.

Server stores the raw responses in a storage device, associating each response with a source identifier and timestamp.

Output: a collection of raw external documents stored in a raw data repository.

### Step 4

Server retrieves internal activity information.

Server executes database queries against an internal information storage resource to obtain campaign descriptions, product specifications, and strategy documents corresponding to the entities identified in Step 2.

Input: query parameters derived from the user request.

Server reads matching records into memory and serializes them as text blocks.

Output: a set of internal text documents and metadata describing the organization's own activities.

### Step 5

Server preprocesses external documents into character-based information.

Server parses each raw external HTML or JSON document using a markup parser to extract visible text content and discards scripts, navigation menus, and style elements.

Input: raw external documents from Step 3.

Server applies tokenization, sentence segmentation, stop-word removal, and lemmatization using a natural language processing library, and normalizes whitespace and character encoding.

Output: cleaned character-based information for each external document, stored as normalized text records with document identifiers.

### Step 6

Server preprocesses internal activity information.

Server applies the same normalization and cleaning pipeline to internal text blocks, including tokenization and removal of boilerplate or template phrases that are not relevant to comparison.

Input: internal text documents from Step 4.

Server generates normalized character-based information for internal campaigns and products and stores them with unique keys.

Output: cleaned internal character-based information ready for analysis.

### Step 7

Server constructs a first prompt sentence for summarization.

Server selects a subset of the cleaned external text relevant to a particular competitor or campaign and concatenates segments up to a token limit.

Input: cleaned external character-based information and context from the user request. Server generates an instruction such as “Summarize the following competitor advertising campaign. Identify target audience, main message, channels used, and unique selling points. Output in 5 bullet points.” and appends the external text after the instruction. This combined text is the first prompt sentence.

Output: a summarization prompt sentence for a generative AI model.

### Step 8

Server calls the generative AI model to generate summary information.

Server converts the summarization prompt sentence into tokens and transmits them to a generative AI model, either locally hosted or accessed via an external API.

Input: tokenized summarization prompt sentence.

The generative AI model performs self-attention computations and forward propagation to produce a sequence of output tokens representing a condensed description of the competitor campaign.

Server decodes the tokens back into text.

Output: competitor campaign summary information in textual form.

### Step 9

Server constructs a second prompt sentence for comparison.

Server combines the internal cleaned text with the competitor summary information and inserts structural markers such as “Section A: Our campaign” and “Section B: Competitor campaign.”

Input: internal character-based information from Step 6 and summary information from Step 8.

Server generates an instruction such as “Compare our internal campaign data (Section A) with the competitor campaign summary (Section B). List similarities and differences, and highlight our potential advantages.” and appends Sections A and B accordingly.

Output: a comparison prompt sentence for the generative AI model.

### Step 10

Server calls the generative AI model to generate comparison and viewpoint information.

Server tokenizes the comparison prompt sentence and provides it to the generative AI model.

Input: tokenized comparison prompt sentence.

The generative AI model processes the tokens and produces output tokens describing similarities, differences, and inferred advantages of the organization.

Server decodes the tokens and labels segments as comparison information and viewpoint information.

Output: structured textual comparison information and viewpoint information regarding the organization's advantages.

### Step 11

Server constructs differentiated expression information and visual information.

Server uses the viewpoint information as context and generates prompt sentences focused on copywriting and visual concepts, such as “Generate three alternative taglines and short body copy that emphasize our advantages identified above,” and “Describe two visual concepts that highlight our advantages versus competitors.”

Input: viewpoint information from Step 10.

Server calls the generative AI model with these prompt sentences and receives textual taglines, body copy, and descriptions of visual elements like comparison charts.

Output: differentiated expression information and visual information stored as text segments and structured visual specifications.

### Step 12

Terminal captures user emotion.

User views interim content or interacts with an application on the terminal.

Terminal activates the camera and microphone and captures facial images and audio samples while content is presented.

Input: real-time image frames and audio signals from the user.

Terminal executes or calls an emotion recognition engine that extracts features such as facial action units and voice pitch and classifies them into an emotional state distribution.

Output: an emotional state descriptor, including labels and confidence scores, transmitted to the server.

### Step 13

Server integrates emotional state into prompt construction.

Server receives the emotional state descriptor and associates it with the active user session and currently displayed content.

Input: emotional state data from the terminal and current context from internal session data. Server constructs an emotion-aware prompt sentence, for example, “Customer emotion: dissatisfaction about price. Rewrite the following proposal to focus on long-term cost savings and risk reduction, and use empathetic wording,” followed by the existing proposal text.

Output: an emotion-aware prompt sentence tailored to the current emotional state.

### Step 14

Server generates emotion-adjusted proposal or advertisement information.

Server tokenizes the emotion-aware prompt sentence and sends it to the generative AI model.

Input: tokenized emotion-aware prompt sentence.

The generative AI model generates new text that adjusts tone, emphasis, and content to align with the emotional state descriptor (e.g., adding reassurance or increasing enthusiasm).

Server decodes the output tokens and stores the adjusted proposal information or advertisement information.

Output: emotion-adjusted proposal information or advertisement information.

### Step 15

Server assembles result information.

Server aggregates summary information, viewpoint information, differentiated expression information, visual information, and emotion-adjusted proposal or advertisement information into a unified data structure.

Input: all generated text and visual specifications from Steps 8, 10, 11, and 14.

Server formats the data into a response object containing sections for analysis, advantages, suggested wording, and suggested visuals.

Output: result information ready for delivery to the terminal.

### Step 16

Server updates history information.

Server records the prompt sentences used, the corresponding model outputs, the emotional state descriptors, and metadata such as timestamps and user identifiers into a history database.

Input: prompt sentences and associated outputs from previous steps.

Server indexes textual elements using vector embeddings and maintains retrieval structures supporting similarity search.

Output: updated history information that can be queried for future reuse and prompt optimization.

### Step 17

Server optimizes future prompt configurations.

Server analyzes history information to determine which prompt configurations correlate with high user acceptance or minimal post-editing.

Input: history information from Step 16 and user feedback data (e.g., acceptance flags, ratings).

Server adjusts parameters of prompt templates, such as maximum word counts, level of detail, and ordering of sections, and stores updated templates for subsequent processing.

Output: refined prompt templates that will be used in future prompt sentence construction.

### Step 18

Server reuses existing summaries and viewpoints when possible.

Server receives a new request and computes similarity between its embedding and embeddings stored in history information.

Input: embedding of the new request and historical embeddings.

If similarity exceeds a threshold, server retrieves existing summary information or viewpoint information and either reuses them directly or constructs a shorter prompt asking the generative AI model to update only changed parts.

Output: reused or lightly updated analytical content that reduces processing load for the new request.

### Step 19

Terminal presents result information to the user.

Terminal receives the result information from the server and renders textual sections and visual elements in a graphical user interface.

Input: result information from Step 15.

Terminal displays summaries, comparisons, advantages, and emotion-adjusted proposals, and provides interface controls for the user to accept, edit, or reject suggested content.

Output: a displayed interface allowing the user to consume and interact with the generated content.

### Step 20

User reviews and provides feedback.

User examines the displayed content, selects suitable taglines, edits proposal text if necessary, and optionally provides explicit ratings or comments.

Input: displayed result information on the terminal.

Terminal records the user's selections, edits, and ratings and transmits them to the server as feedback data.

Output: feedback data that the server uses to refine history information and future prompt sentence configurations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

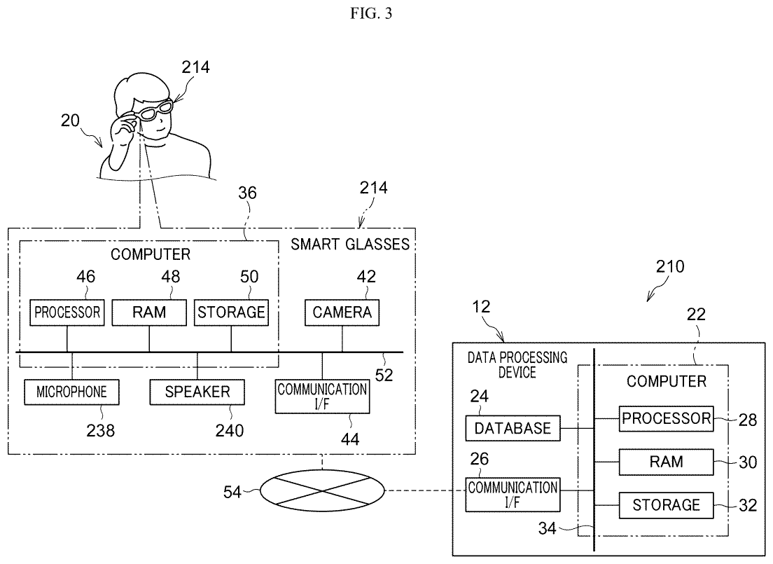

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

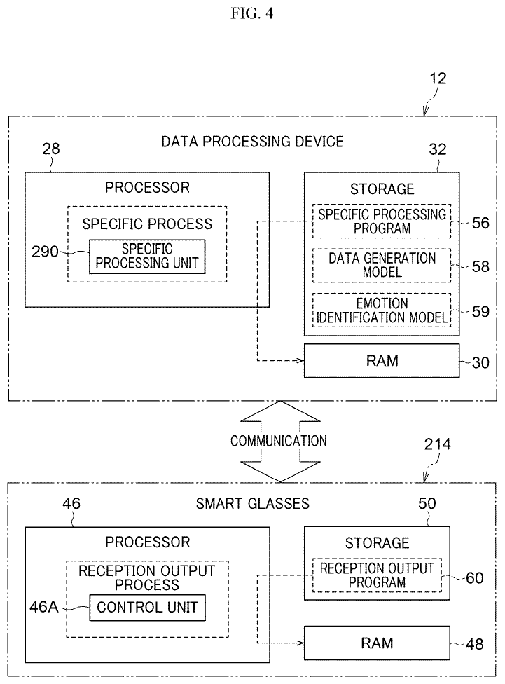

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

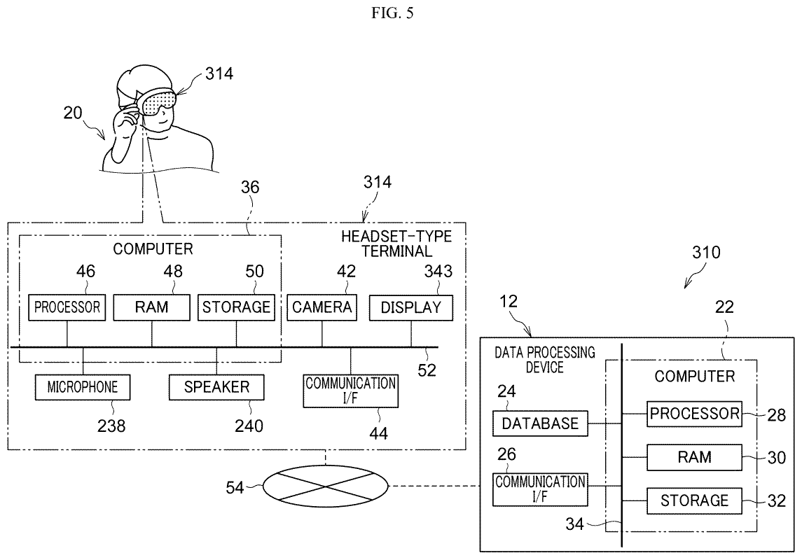

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

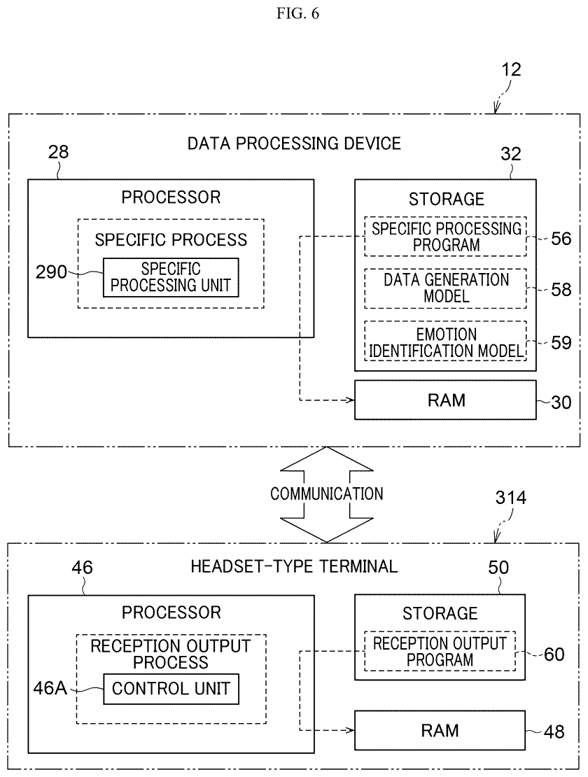

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

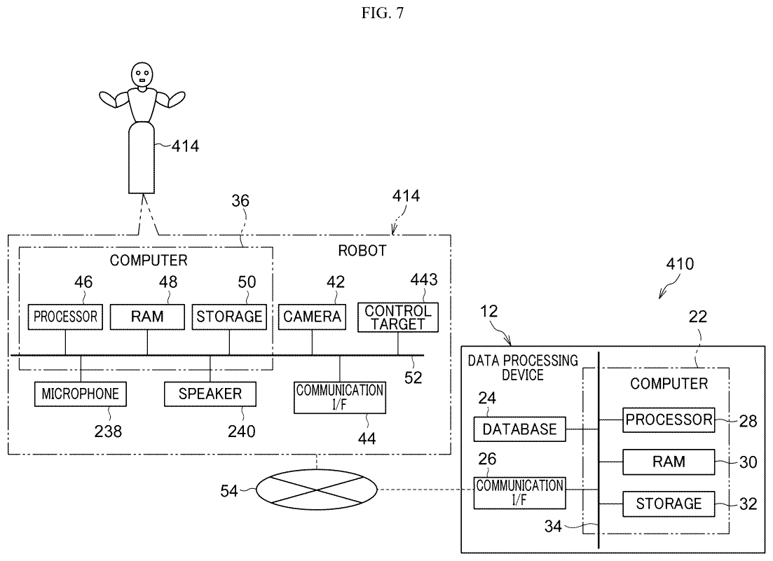

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

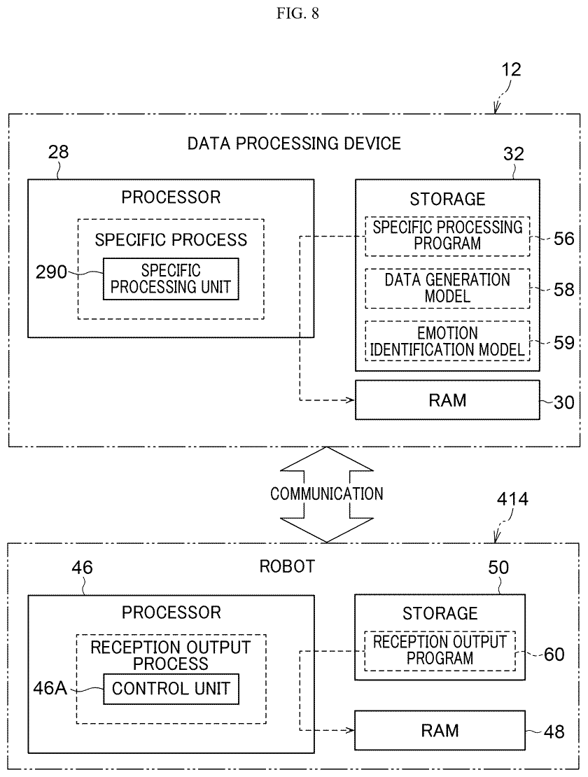

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

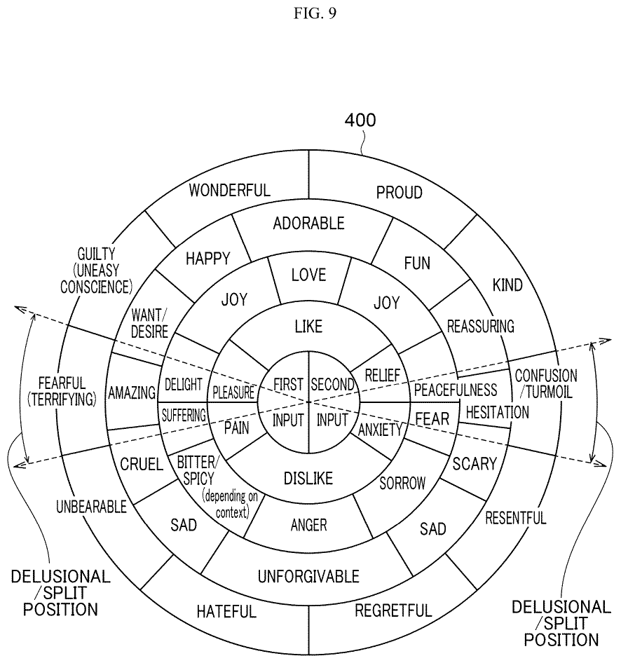

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

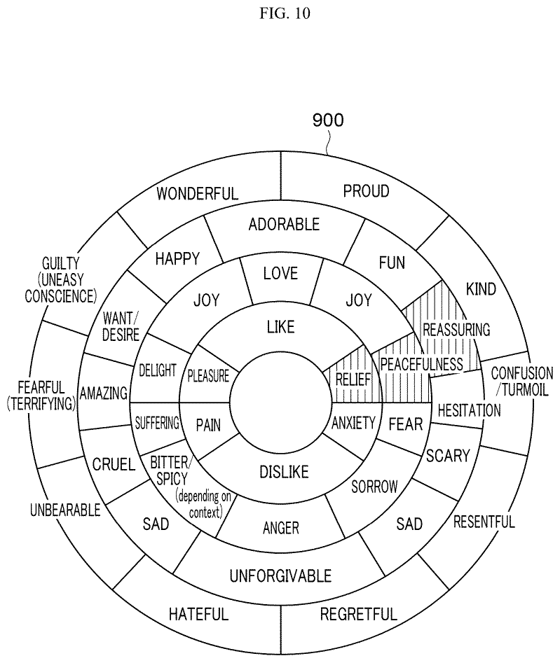

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### Supplementary 1

A system comprising a processor,

wherein the processor is configured to

acquire, by an information acquisition module, document data relating to a competitive entity from a communication network or an information storage device, and

convert, by a preprocessing module, the document data from a document format into a character information format and format the character information format by deleting unnecessary line breaks and special symbols using a script described in a programming language, and

transmit, by a communication module, the formatted character information format to an external processing apparatus via an encrypted communication scheme, and

transmit, by an analysis module, inquiry information including a prompt sentence for instructing generation of a summary of the formatted character information format to a generative AI model operating on the external processing apparatus, and obtain response information including the summary from the generative AI model, and

store, by a management module, the document data and the summary in a storage device in association with each other and manage identification information of the document data, processing state information, and identification information of the generative AI model, and

provide, by an output module, the summary to a user terminal via electronic communication.

### Supplementary 2

The system according to supplementary 1,

wherein the processor is configured to

generate, by the analysis module, the prompt sentence using natural language processing and include, in the prompt sentence, a viewpoint of a target of summarization and an output format so as to control contents of analysis performed by the generative AI model.

### Supplementary 3

The system according to supplementary 1,

wherein the processor is configured to

set, by the analysis module, the prompt sentence such that the summary obtained from the generative AI model includes information relating to a business policy, a provision target, a technical feature, and an implementation timing of the competitive entity, and cause the management module to store the summary together with identification information and retain the summary in a searchable manner.

### Application Example 1

### Supplementary 1

A system comprising a processor and a storage device,

wherein the processor is configured to

acquire, via a communication network or from an information storage device, structured data or unstructured data related to information provision activities of other organizations from a plurality of information sources,

extract, from the acquired data, predetermined structural information and remove display structure elements and advertisement elements to normalize the acquired data as natural language text data,

generate content-based identification information for the natural language text data, compare the identification information with identification information of previously processed data, determine whether the information provision activity is new or updated, and select only the new or updated information provision activity as a target for subsequent processing, dynamically generate a prompt sentence that specifies summarization conditions and extraction items in accordance with attribute information and a content type of the selected natural language text data, and structure input data including the prompt sentence and the natural language text data into a format acceptable by a generative AI model, transmit, via the communication network, the input data to the generative AI model, receive a summary text and feature information generated in accordance with the prompt sentence from the generative AI model, and store the summary text and the feature information in the storage device,

classify a plurality of the summary texts and the feature information by at least one of an organization unit, a product or service category unit, and a time unit, and generate organized result data indicating trends and differences of a plurality of information provision activities by performing comparison and organization using natural language processing technology and statistical processing technology,

select, as notification targets, at least one of the organized result data and the summary texts that satisfy a predetermined condition, generate notification data including notification title information and notification body information, and transmit the notification data to a user terminal via a message delivery service or a notification delivery device,

cause the user terminal to display the summary text and the organized result data based on the received notification data, receive importance evaluation information or relevance evaluation information from a user, and transmit the evaluation information to the processor, and update, based on the evaluation information, at least one of the summarization conditions and the extraction items of the prompt sentence and selection conditions for the notification targets.

### Supplementary 2

The system according to supplementary 1,

wherein the processor is configured to extract, from the summary text and the feature information acquired from the generative AI model, attribute information related to appeal content, target market, pricing, or positioning in the information provision activities of the other organizations, generate analysis information indicating an advantage or differentiation factor in information provision activities of an own organization, and include the analysis information in the organized result data.

### Supplementary 3

The system according to supplementary 1,

wherein the processor is configured to, when generating the prompt sentence, automatically adjust a granularity of the summary, an output format, and a number of items to be extracted based on at least one of a length of the natural language text data, a type of an acquisition source, and past evaluation information, and update the prompt sentence to be transmitted to the generative AI model.

### EXAMPLE 2

### Supplementary 1

A system comprising a processor,

wherein the processor is configured to

acquire character information including information regarding a first organization and information regarding a second organization from a communication network or a storage device, convert the character information into a machine-readable format, remove unnecessary information, and generate normalized data,

generate a prompt sentence corresponding to the normalized data by using a natural language processing technique, and input the prompt sentence and the normalized data to a generative AI model so as to cause the generative AI model to generate summary information respectively for the information regarding the first organization and the information regarding the second organization,

execute natural language processing including morphological analysis processing and frequency calculation processing on the summary information, and extract keywords and topics to generate, as structured data, feature information regarding the first organization and feature information regarding the second organization,

calculate common elements and different elements between the feature information regarding the first organization and the feature information regarding the second organization on the basis of the structured data, and generate comparison information including an occurrence degree and a difference index for each of the elements,

generate image information including at least one of a bar graph and a line graph for visualizing the comparison information by using a statistical processing program and a drawing library, and generate display data capable of being output to a terminal on the basis of the image information, and

transmit the summary information, the comparison information, and the display data to a user terminal, and present the summary information, the comparison information, and the display data as an analysis result to support strategic decision-making by a user.

### Supplementary 2

The system according to supplementary 1,

wherein the processor is configured to

generate an additional prompt sentence on the basis of the summary information, input the additional prompt sentence and the summary information to the generative AI model to cause the generative AI model to generate a refined summary that presents key points in a list format respectively for the information regarding the first organization and the information regarding the second organization, and use the refined summary for generation of the comparison information.

### Supplementary 3

The system according to supplementary 1,

wherein the processor is configured to

compare the occurrence degree of each keyword included in the structured data between the information regarding the first organization and the information regarding the second organization, classify emphasized elements regarding the first organization and emphasized elements regarding the second organization, generate a prompt sentence for inputting the classification result to the generative AI model, cause the generative AI model to generate explanatory information including an interpretation of the classification result and improvement measure proposals, and present the explanatory information to the user terminal.

### Application Example 2

### Supplementary 1

A system comprising a processor,

wherein the processor is configured to

automatically collect organization-related information from a network resource and an information storage resource,

convert the collected information into character-based information and perform preprocessing that removes format information and unnecessary information from the character-based information,

construct a prompt sentence, based on the preprocessed character-based information and internal activity information of an organization, the prompt sentence being configured to instruct a generative AI model to perform analysis and summarization of the information, input the prompt sentence and the character-based information into the generative AI model and cause the generative AI model to generate summary information regarding a competitive organization,

compare the summary information with the internal activity information of the organization and generate viewpoint information regarding an advantage of the organization by extracting common points and differences,

construct differentiated expression information and visual information for sales activity or promotion activity, based on the viewpoint information,

acquire an emotional state of a user by using an emotion recognition technology, input the emotional state into the generative AI model together with the prompt sentence and cause the generative AI model to generate proposal information or advertisement information adjusted according to the emotional state, and

provide result information including the summary information, the viewpoint information, and the proposal information or the advertisement information to an output information processing terminal.

### Supplementary 2

The system according to supplementary 1,

wherein the processor is configured to

store the prompt sentence, the summary information, the viewpoint information, the emotional state, and the result information as history information, and update a configuration of the prompt sentence based on the history information so as to sequentially improve information generation performance of the generative AI model.

### Supplementary 3

The system according to supplementary 1,

wherein the processor is configured to

identify, based on the history information, organization information or competitive organization information similar to newly processed information, and shorten processing time for a new user request by reusing or partially updating existing summary information or viewpoint information.

What is claimed is:

1. A system comprising:
circuitry configured to:
acquire, via a communication interface coupled to a packet-switched network, document data from a communication network or an information storage apparatus, and store the document data in a storage device;
convert the document data from a document format into a character information format, and format the character information format by removing noise elements including unnecessary line breaks and special symbols using a preprocessing script, to generate normalized text data;
transmit, via the communication interface, the normalized text data to an external processing apparatus using an encrypted communication scheme;
generate a prompt sentence that specifies summarization conditions and extraction items, transmit inquiry information including the prompt sentence to a generative neural network model operating on the external processing apparatus, and receive response information including a summary from the generative neural network model; and
store the document data and the summary in the storage device in association with each other, manage identification information of the document data, processing state information, and identification information of the generative neural network model, and transmit the summary to a terminal device via the communication interface.

2. The system according to claim 1, wherein the circuitry is configured to extract predetermined structural information from the acquired document data, remove display structure elements and advertisement elements, and normalize the acquired document data as natural language text data for use as the character information format.

3. The system according to claim 2, wherein the circuitry is configured to generate content-based identification information for the natural language text data, compare the identification information with identification information of previously processed data stored in the storage device, and select only new or updated document data as a target for subsequent processing.

4. The system according to claim 3, wherein the circuitry is configured to generate the prompt sentence by applying natural language processing to the natural language text data to extract attribute information and content type, and dynamically constructing the prompt sentence based on the extracted attribute information and content type to control analysis contents of the generative neural network model.

5. The system according to claim 4, wherein the circuitry is configured to include in the prompt sentence a viewpoint of a target of summarization and an output format specifying structure of the summary, and to instruct the generative neural network model to generate the summary according to the specified output format.

6. The system according to claim 1, wherein the circuitry is configured to store the summary in the storage device together with identification information in a searchable manner, and to generate a structured report by aggregating stored summaries for a plurality of document data records matching a search condition, and transmit the report to the terminal device.

7. The system according to claim 6, wherein the circuitry is configured to structure the report by generating an aggregation prompt that instructs the generative neural network model to compare summaries across multiple document data records and identify differences, trends, and notable changes, and transmit the aggregated result to the terminal device via the communication interface.

8. The system according to claim 1, wherein the circuitry is configured to detect a notification trigger condition based on the content of the summary, and generate a notification message that includes key extracted items from the summary and transmit the notification message to the terminal device via the communication interface.

9. The system according to claim 8, wherein the circuitry is configured to evaluate the notification trigger condition by applying a keyword matching algorithm and a relevance scoring function to the summary, and generating the notification message when a relevance score exceeds a threshold.

10. The system according to claim 1, wherein the circuitry is configured to acquire structured data or unstructured data from a plurality of information sources via the communication interface, and merge the acquired data from the plurality of sources into a unified document data set by deduplicating records based on content-based identification information.

11. The system according to claim 10, wherein the circuitry is configured to generate a merged summary prompt that instructs the generative neural network model to synthesize summaries across the unified document data set, and store the merged summary in the storage device associated with cross-source reference identifiers.

12. The system according to claim 1, wherein the circuitry is configured to manage version history of document data and associated summaries in the storage device, and detect updated versions of previously processed document data by comparing content-based identification information against stored records.

13. The system according to claim 12, wherein the circuitry is configured to generate an update-focused prompt sentence that instructs the generative neural network model to identify differences between a current summary and a prior summary for updated document data, and transmit a differential summary to the terminal device.

14. The system according to claim 1, wherein the circuitry is configured to receive a search query from the terminal device via the communication interface, execute a full-text search and a semantic-similarity search on stored summaries and document data, and transmit ranked search results to the terminal device.

15. The system according to claim 14, wherein the circuitry is configured to perform the semantic-similarity search by computing dense vector embeddings for stored summaries using a pre-trained encoder, constructing a vector search index, and ranking results by cosine similarity between query embedding and stored embeddings.

16. The system according to claim 1, wherein the circuitry is configured to store the prompt sentence, inquiry information, and response information as processing history in the storage device in association with the document data, and use the processing history to monitor processing completeness and identify document data records that require reprocessing.

17. The system according to claim 16, wherein the circuitry is configured to detect a processing failure condition for a document data record based on the processing state information stored in the storage device, and generate a retry request that re-transmits the inquiry information to the generative neural network model via the communication interface.

18. A system comprising:
circuitry configured to:
acquire, via a communication interface coupled to a packet-switched network, document data from a communication network or an information storage apparatus, and convert the document data to character information format by removing noise elements using a preprocessing script;
generate content-based identification information, compare against previously processed records in a storage device to identify new or updated document data, and select new or updated document data for processing;
dynamically generate a prompt sentence specifying summarization conditions and extraction items based on attribute information and content type of the selected document data, transmit inquiry information including the prompt sentence and the character information format to a generative neural network model via the communication interface, and receive a summary;
store the document data and the summary in the storage device with identification information and processing state information; and
aggregate stored summaries based on a search condition, generate a report by operating the generative neural network model with an aggregation prompt, and transmit the report and the summary to a terminal device via the communication interface.

19. The system according to claim 18, wherein the circuitry is configured to compute dense vector embeddings for stored summaries, construct a vector search index, and rank search results by cosine similarity between a query embedding and stored embeddings.

20. A method comprising:
acquiring, via a communication interface coupled to a packet-switched network, document data from a communication network or an information storage apparatus, and storing the document data in a storage device;
converting the document data from a document format into a character information format, and formatting the character information format by removing noise elements including unnecessary line breaks and special symbols, to generate normalized text data;
transmitting, via the communication interface, the normalized text data to an external processing apparatus using an encrypted communication scheme;
generating a prompt sentence that specifies summarization conditions and extraction items, transmitting inquiry information including the prompt sentence to a generative neural network model, and receiving response information including a summary; and
storing the document data and the summary in the storage device in association with each other with identification information and processing state information, and transmitting the summary to a terminal device via the communication interface.
